(19) United States
(12) Patent Application Publication
(10) Pub. No.: US 2017/0314539 A1
(43) Pub. Date: Nov. 2, 2017

(54) ROTATION-TYPE ACTUATOR ACTUATED BY TEMPERATURE FLUCTUATION OR TEMPERATURE GRADIENT AND ENERGY HARVESTING DEVICE USING SAME

(71) Applicant: (IUCF-HYU (INDUSTRY-UNIVERSITY COOPERATION FOUNDATION HANYANG UNIVERSITY), Seongdong-gu, Seoul (KR)

(72) Inventors: Seonjeong KIM, Seoul (KR); Shihyeong KIM, Seoul (KR)

(73) Assignee: Industry-University Cooperation Foundation Hanyang University, Seoul (KR)

(21) Appl. No.: 15/521,063

(22) PCT Filed: Oct. 22, 2015
(86) PCT No.: PCT/KR2015/011203

§ 371 Date: Apr. 21, 2017

(30) Foreign Application Priority Data
Oct. 22, 2014 (KR) 10-2014-0143310
Jan. 26, 2015 (KR) 10-2015-0012035

(51) Int. Cl. F03G 7/06; F03G 1/04; F03G 1/06; H02K 7/18

(52) U.S. Cl. CPC F03G 7/065; H02K 7/1853; F03G 1/04; F03G 1/06

(57) ABSTRACT

The present invention relates to a rotation-type actuator which includes a fiber having a twisted structure, which is manufactured by rotating the fiber in the opposite directions. Here, the fiber is divided into a top portion and a bottom portion with respect to the center thereof, at least one of the top and bottom portions of the fiber is fixed, and the top and bottom portions of the fiber each independently have a coiled shape as a chiral Z-type or chiral S-type structure. The rotation-type actuator has an excellent rotation speed, and also exhibits no significant decrease in rotation speed due to excellent durability and stability even when used for a long period of time. In addition, the rotation-type actuator uses a polymer fiber manufactured through electro spinning alone or using a polymer sheet obtained by aligning the polymer fiber in a single direction, and can efficiently convert heat energy, which is wasted in the air, into mechanical energy without providing a high temperature fluctuation since the rotation-type actuator has reversible, rapid and efficient actuation using persistent temperature gradient supplied from a temperature difference present in surrounding environments. Accordingly, energy harvesting devices, having improved efficiency and excellent service life characteristics in recovering heat energy as electrical energy using the rotation-type actuator, can be provided.

### TECHNICAL FIELD

The present invention relates to a rotation-type actuator actuated by a temperature fluctuation or a temperature gradient and an energy harvesting device using the same, and more particularly, to a rotation-type actuator capable of rotating repeatedly and continuously in response to a temperature fluctuation or a temperature gradient so as to convert heat energy, which has been wasted in surrounding environments, into mechanical energy, and an energy harvesting device having excellent efficiency and capable of generating electrical energy using the same.

### BACKGROUND ART

Energy harvesting technology refers to technology of converting types of energy, such as vibration energy, thermal energy, light energy, RF energy, and the like, which are present in surrounding environments and have been wasted therein, into electrical energy. Why such technology has attracted great attention is because the density of harvested electrical energy gradually increases with continuous advancement of an energy harvesting structure and performance.

The energy harvesting technology includes a method of converting a difference in temperature into electrical energy using a thermoelectric effect. This method using the thermoelectric effect uses a thermoelectric material in which a voltage is generated due to a difference in temperature thereof, and thus has an advantage in that electrical energy can be obtained from the human body temperature or waste heat. However, the method has drawbacks in that a potential difference may occur only when there is a constant difference in temperature, and it has very low efficiency.

To solve the above problems, various artificial muscles in which actuation such as folding, up-down motion, or rotation is derived from heat energy such as a temperature fluctuation, electrochemical energy, chemical energy, thermal energy, or humidity have been developed.

When an actuator is electrochemically or thermally stimulated or stimulated by light, the actuator shows movement in a linear, rotation or contraction form. Such an actuator has been developed as an actuator in which a carbon nanotube fiber (Non-patent Document 1), a polymer fiber including mono- and multi-filaments (Non-patent Document 2), a graphene oxide fiber (Non-patent Document 3) and the like have a twisted structure, and such fibrous muscles have been found to have various effects such as an excellent bending property, linear movement and a high rotation angle.

By way of one example, a carbon nanotube yarn in a twisted and coiled shape (Non-patent Documents 1 and 4) exhibited rotational actuation approximately 1,000 times higher than conventional general carbon nanotube yarn. That is, this technology shows that the carbon nanotube yarn in the above-described shape may be induced to be rotationally actuated from thermal energy or may be self-actuated by a varying temperature.

However, a voltage is applied based on the high electroconductive characteristics so that the carbon nanotube yarn having such a structure contracts or expands in response to the application of the voltage, thereby converting electrical energy into heat energy or rotational energy. Also, the carbon nanotube yarn has a problem in that heat energy in external environments is not sufficiently used in daily life due to low efficiency of conversion generated through the contraction or expansion.

It is not only the above-listed techniques that have such aforementioned limitations. The currently developed actuators do not satisfy all the properties such as durability, stability, service life, etc. Therefore, when they are improved to develop an actuator capable of converting wasted heat in the air into rotating, moving up and down, and electricity through a high-efficiency process, they may have an improvement point in the field of nanotechnology.

Meanwhile, in addition to the carbon nanotube-based actuators, a pyroelectric material for storing energy from a temperature fluctuation (Non-patent Document 5), a hybrid piezoelectric system using polymer expansion (Non-patent Document 6), and a shape memory alloy (Non-patent Document 7) have been developed, but have problems in that they all require an elaborate polarization process, should have a high temperature fluctuation to convert heat energy into mechanical energy or electrical energy, and cannot rapidly and efficiently use heat energy present in the surrounding environments due to low flexibility and elasticity. Therefore, the use of the materials has a limitation in use as an energy conversion device.

Accordingly, the present inventors have endeavored to develop a rotation-type actuator capable of being actuated in response to a temperature fluctuation in ordinary environments and being reversibly, rapidly and efficiently self-actuated as well as solving the above problems, and developed a rotation-type actuator according to the present invention.

(Non-patent Document 1) Lima, M. D., et al. Electrically, Chemically, and Photonically Powered Torsional and Tensile Actuation of Hybrid Carbon Nanotube Yarn Muscles. Science 334, 928-932 (2012)

(Non-patent Document 2) Haines, C. S., et al. Artificial Muscles from Fishing Line and Sewing Thread. Science 343, 868-872 (2014).

(Non-patent Document 3) Cheng, H., et al. Moisture-Activated Torsional Graphene-Fibre Motor. Adv. Mater. (2014).

(Non-patent Document 4) J. Foroughi, G. M. Spinks, G. G. Wallace, J. Oh, M. E. Kozlov, S. L. Fang, T. Mirfakhrai, J. D. W. Madden, M. K. Shin, S. J. Kim, R. H. Baughman, Science 2011, 334, 494.

(Non-patent Document 5) Y. Yang, S. Wang, Y. Zhang, Z. L. Wang, Nano Lett. 2012, 12, 6408.

(Non-patent Document 6) X. Wang, K. Kim, Y. Wang, M. Stadermann, A. Noy, A. V. Hamza, J. Yang, D. J. Sirbuly, Nano Lett. 2010, 10, 4091.

(Non-patent Document 7) D. Zakharov, G. Lebedev, O. Cugat, J. Delamare, B. Viala, T. Lafont, L. Gimeno, A. Shelyakov, J. Micromech. Microeng. 2012, 22, 094005.

### DISCLOSURE

### Technical Problem

Therefore, the present invention is designed to solve the problems of the prior art, and it is an object of the present invention to provide a rotation-type actuator capable of contracting or expanding according to a temperature fluctuation and causing rotation when some or all of the actuator is heated by improving a structure of the actuator.

It is another object of the present invention to provide an energy harvesting device capable of converting heat energy, which is wasted in the air, into electrical energy using the rotation-type actuator.

It is still another object of the present invention to provide an energy harvesting device capable of converting heat energy, which is wasted in the air, into potential energy or electrical energy using the rotation-type actuator.

It is yet another object of the present invention to provide a rotation-type actuator sensitive to heat, in which a temperature gradient is caused due to a difference in ambient temperature so that the rotation-type actuator is actuated.

It is yet another object of the present invention to provide an energy harvesting device having various shapes using the rotation-type actuator.

### Technical Solution

To solve the above problems, according to an aspect of the present invention, there is provided a rotation-type actuator which includes a single fiber or a multi-fiber having a twisted structure, which is manufactured by rotating the fiber in the same direction or opposite directions. Here, the fiber may be divided into a top portion and a bottom portion with respect to the center thereof, at least one of the top and bottom portions of the fiber is fixed, and the top and bottom portions of the fiber each independently have a twisted structure or a coiled shape as a chiral Z-type or chiral S-type structure. The fiber may include any one selected from the group consisting of polymer materials such as nylon, shape-memory polyurethane, polyethylene, and rubber. The rotation-type actuator may have a rotating force due to contraction or expansion of the rotation-type actuator caused by a temperature fluctuation when both of the top and bottom portions of the rotation-type actuator are fixed.

The rotation-type actuator may have a change in rotating force and length due to the contraction or expansion of the rotation-type actuator caused by the temperature fluctuation when only one of the top and bottom portions of the rotation-type actuator is fixed. The rotation-type actuator having the twisted structure may have a bias angle of 20 to 60°. When both of the top and bottom portions of the rotation-type actuator are fixed, the rotation-type actuator may be tensile strained 1 to 25% before being fixed, based on the total length of the rotation-type actuator. When only one of the top and bottom portions of the rotation-type actuator is fixed, a change in length according to temperature may be in a range of 5 to 30%, based on the total length of the rotation-type actuator.

The rotation-type actuator may have a rotation speed of 100 to 200,000 rpm, depending on the temperature fluctuation. Also, the present invention provides a rotation-type actuator having a 2-ply structure, characterized in that the rotation-type actuator has a 2-ply structure consisting of two strands, and is actuated like one strand. When the two strands of the rotation-type actuator have chiral S-type structures, the rotation-type actuator may have an SZ coiled shape as the two strands of the rotation-type actuator are coiled in a Z type to form a 2-ply structure. When the two strands of the rotation-type actuator have chiral Z-type structures, the rotation-type actuator may have a ZS coiled shape as the two strands of the rotation-type actuator are coiled in an S type to form a 2-ply structure.

According to another aspect of the present invention, there is provided an energy harvesting device which includes the rotation-type actuator defined in claim 1 which contracts or expands in response to a temperature fluctuation; at least one magnetic material or coil located at a position inside the rotation-type actuator and rotating as the actuator rotates; and at least one coil or magnetic material arranged spaced apart from the rotation-type actuator.

The magnetic material may rotate as the rotation-type actuator rotates while contracting or expanding in response to the temperature fluctuation, and may induce a change in magnetic flux passing through the interior of the coil to generate electrical energy.

Both end portions of the rotation-type actuator may be fixed, or only one of the end portions of the rotation-type actuator may be fixed. When one end portion of the rotation-type actuator is fixed, the energy harvesting device may further include a position variation support formed at the other unfixed end portion of the rotation-type actuator.

The magnetic material may be a permanent magnet, and the weight of the magnetic material may be 10 to 1000 times higher than that of the rotation-type actuator.

The position variation support may be a magnetic material.

The energy harvesting device may include a surrounding coil arranged spaced apart from the position variation support, and electrical energy may be generated through a change in magnetic flux passing through the interior of the coil while the position variation support is moving in a horizontal direction when the rotation-type actuator is strained or contracted in response to the temperature fluctuation. The energy harvesting device may further include a plate attached to one of bottom and top portions of the energy harvesting device; and an opening/closing port configured to open or close the plate, and may further include at least one pin located at one position of the rotation-type actuator, arranged spaced apart from the plate and having the same shape as the opening/closing port.

The rotation-type actuator rotates in response to a temperature, and the pin is located at a horizontal position spaced apart from the opening/closing port as the rotation-type actuator rotates, thereby blocking a flow of air flowing in through the opening/closing port. A spacing between the pin and each plate provided with the opening/closing port may be in a range of 0.1 to 3 cm.

According to still another aspect of the present invention, there is provided an energy harvesting device which includes the rotation-type actuator having both end portions fixed on a horizontal axis and contracting or expanding in response to a temperature fluctuation; an elevation unit provided at a central point in the rotation-type actuator; at least one magnetic material provided at a lower portion of the elevation unit and coupled to the elevation unit to have a change in location as the rotation-type actuator rotates; and at least one coil configured to generate an electric field through up-down movement of the magnetic material. The coil may be in a cylindrical shape to surround a lateral surface of the magnetic material. Also, the coil may be located at a lateral surface or bottom surface of the magnetic material to generate an electric field through the up-down movement of the magnetic material. The magnetic material has a change in location in a vertical axis direction as the rotation-type actuator rotates while contracting or expanding in response to the temperature fluctuation, and the change in position of the magnetic material may cause a change in spacing between the coil and the magnetic material to induce a change in magnetic flux passing through the coil, thereby generating electrical energy. The location change distance of the magnetic material in the vertical axis direction may be in a range of 0.1 to 3 cm. The elevation unit may be a pulley.

According to yet another aspect of the present invention, there is provided a rotation-type actuator which includes at least one polymer fiber or a polymer sheet formed by aligning the polymer fiber in one direction. Here, the at least one polymer fiber or polymer sheet has a top portion and a bottom portion divided with respect to the inner part thereof, and at least one of the top and bottom portions of the at least one polymer fiber or polymer sheet is fixed, and the at least one polymer fiber or polymer sheet has a twisted or coiled shape manufactured by rotating the top and bottom portions in the same direction or opposite directions. Here, when a temperature gradient occurs between a portion and the other portion of the rotation-type actuator, a difference in volume between the portion and the other portion of the rotation-type actuator is caused, resulting in continuous rotation. The polymer fiber may include any one selected from the group consisting of polymer materials such as nylon, polyurethane, polyethylene, and rubber, etc. The temperature gradient between portion and the other portion of the rotation-type actuator may be greater than or equal to 1° C. The rotation-type actuator may have a diameter of 0.5 to 200 μm. The maximum temperature of the rotation-type actuator may be in a range of 20 to 80° C.

When the top and bottom portions of the at least one polymer fiber or polymer sheet rotate in the same direction or opposite directions to be manufactured into the rotation-type actuator, the rotation-type actuator may be manufactured by rotating the top and bottom portions of the at least one polymer fiber or polymer sheet at a twist number of 2,000 to 60,000 turns/m and a temperature higher than the glass transition temperature (T_{g}) of the polymer fiber or polymer sheet. The rotation-type actuator may be fixed after the rotation-type actuator is strained 10 to 60% before being fixed, based on the total length of the rotation-type actuator. Also, the present invention provides a rotation-type actuator having a 2-ply structure, characterized in that the rotation-type actuator has a 2-ply structure consisting of two strands of the rotation-type actuator, and is actuated like one strand.

According to yet another aspect of the present invention, there is provided an energy harvesting device which includes the rotation-type actuator configured to provide continuous rotation due to a temperature gradient, at least one magnetic material or coil located at a position inside the rotation-type actuator and rotating as the rotation-type actuator rotates, and at least one coil or magnetic material arranged spaced apart from the rotation-type actuator. The magnetic material may rotate as the rotation-type actuator rotates in response to a temperature gradient, thereby inducing a change in magnetic flux passing through the interior of the coil to generate electrical energy. The magnetic material may be a permanent magnet, and the weight of the magnetic material may be 1 to 1000 times higher than that of the rotation-type actuator. Both end portions of the rotation-type actuator may be fixed, or only one of the end portions of the rotation-type actuator may be fixed. When one end portion of the rotation-type actuator is fixed, the energy harvesting device may further include a position variation support formed at the other unfixed end portion of the rotation-type actuator.

The position variation support may be a magnetic material, and the energy harvesting device may include a surrounding coil arranged spaced apart from the position variation support. In this case, when the rotation-type actuator is strained or contracted in response to the temperature gradient, electrical energy may be generated through a change in magnetic flux passing through the interior of the coil while the position variation support is moving in a horizontal direction. According to yet another aspect of the present invention, there is provided an energy harvesting device which includes a plate attached to one of bottom and top portions of the energy harvesting device, and an opening/closing port configured to open and close the plate, and further includes at least one pin located at one position of the rotation-type actuator, arranged spaced apart from the plate and having the same shape as the opening/closing port. The rotation-type actuator may be rotated due to a temperature gradient, and the pin may be located at a horizontal position spaced apart from the opening/closing port as the rotation-type actuator rotates, thereby blocking a flow of air flowing in through the opening/closing port. A spacing between the pin and each plate provided with the opening/closing port may be in a range of 0.1 to 3 cm.

According to yet another aspect of the present invention, there is provided an energy harvesting device which includes the rotation-type actuator having both end portions fixed on a horizontal axis and rotating in response to a temperature gradient, an elevation unit provided at a central point in the rotation-type actuator, at least one magnetic material provided at a lower portion of the elevation unit and coupled to the elevation unit to have a change in location as the rotation-type actuator rotates, and at least one coil configured to generate an electric field through up-down movement of the magnetic material.

The coil may be in a cylindrical shape to surround a lateral surface of the magnetic material. The coil may be located at a lateral surface or bottom surface of the magnetic material to generate an electric field through the up-down movement of the magnetic material. The magnetic material moves up and down as the rotation-type actuator rotates in response to a temperature gradient, and a change in position of the magnetic material may cause a change in spacing between the coil and the magnetic material to induce a change in magnetic flux passing through the coil so as to generate electrical energy. An up-down movement distance of the magnetic material may be in a range of 0.1 to 3 cm. The elevation unit may be a device configured to convert rotation energy into potential energy.

### Advantageous Effects

The rotation-type actuator according to the present invention responds immediately, sensitively and reversibly to a temperature fluctuation by modifying a fiber to have a twisted and coiled structure.

Also, the rotation-type actuator according to the present invention can efficiently convert heat energy, which is wasted in the air, into mechanical energy without providing a high temperature fluctuation since the rotation-type actuator is sensitive to a persistent temperature gradient supplied from a temperature difference present in surrounding environments and has reversible, rapid and efficient actuation using a polymer fiber manufactured through electrospinning alone or using a polymer sheet obtained by aligning the polymer fiber in a single direction. In this case, twists are applied to the polymer fiber or the polymer sheet.

The rotation-type actuator has an excellent rotation speed, and also exhibits excellent service life characteristics since there is no significant decrease in rotation speed due to excellent durability and stability even when used for a long period of time. Accordingly, various types of the energy harvesting devices having improved efficiency in recovering heat energy as electrical energy using the rotation-type actuator, can be provided.

### DESCRIPTION OF DRAWINGS

The above and other objects, features and other advantages of the present invention will be more clearly understood from the following detailed description taken in conjunction with the accompanying drawings, in which:

FIG. 1 shows examples of the structures which rotation-type actuators according to embodiments of the present invention may have;

FIG. 2 shows a cross-sectional view showing a configuration of an energy harvesting device according to an embodiment of the present invention, and an actual image of the energy harvesting device;

FIG. 3 shows a cross-sectional view of an energy harvesting device according to another embodiment of the present invention (A), an image obtained by photographing the energy harvesting device viewed from the above (B), and an image obtained by photographing the energy harvesting device viewed from the side (C);

FIG. 4 is a cross-sectional view of an energy harvesting device according to a still another embodiment of the present invention;

FIG. 5 shows SEM images of rotation-type actuators according to embodiments of the present invention;

FIG. 6 is a graph showing temperature, voltage and rotation number according to time measured from the energy harvesting device manufactured in Preparative Example 5 to measure the rotation speed and rotation number (rotation angle) of the rotation-type actuator in response to a temperature fluctuation;

FIG. 7a is a graph showing rotation speeds of the actuators (ZZ-C and ZS-C) manufactured in Preparative Examples 1 and 4 in response to a temperature fluctuation, FIG. 7b is a graph showing rotation speeds of the actuators (ZZ-C and ZS-C) manufactured in Preparative Examples 1 and 4 in response to a tensile strain, FIG. 7c is a graph showing rotation speeds of the actuators (ZZ-C and ZS-C) manufactured in Preparative Examples 1 and 4 in response to a moment of inertia of the magnetic material, and FIG. 7d is a graph showing a rotation speed of the actuator (ZS-C) manufactured in Preparative Example 4 in response to the number of heating/cooling cycles. In this case, the actuator (ZS-C) manufactured in Preparative Example 4 and having a diameter of 27 μm and an entire length of 95 mm was used. In FIG. 7a, a graph plotted for the rotation angle according to temperature is denoted by hollow figures, and a graph plotted from for the rotation speed according to temperature is denoted by filled figures;

FIG. 8 shows graphs showing results of comparison of rotation speeds according to the temperature of the actuators (ZS-C, ZS-N, ZZ-C and ZZ-N) having various structures according to the present invention;

FIG. 9 is a graph showing results obtained by measuring the rotation number and tensile actuation of the actuator (ZZ-C, Preparative Example 3) provided with a different load (1.2 g, 2.1 g, 3.1 g, or 4.1 g) of the position variation support according to time so as to check an effect of the load of the position variation support which makes the actuator to only change position without being rotated and is located below the actuator;

FIG. 10a is an actual image of the actuator (ZS-C) manufactured in Preparative Example 4, which is stretched by 20%, FIG. 10b is an actual image of the actuator (ZS-C) manufactured in Preparative Example 4, which is irreversibly changed in a state in which a partially coiled structure is untwisted, and FIG. 10c is a graph showing a change in rotation angle with an increasing temperature of the actuator (ZS-C) manufactured in Preparative Example 4, which is stretched by 15%;

FIG. 11 is a graph showing results of measuring and comparing a rotation speed according to the stretching degree of the actuator (ZS-C) manufactured in Preparative Example 4 so as to check an effect of a spring index on the actuator of the present invention;

FIG. 12a is a graph showing results of measuring a rotation speed of the actuator (ZS-C) manufactured in Preparative Example 4 according to humidity, and FIG. 12b is a graph showing results of measuring a rotation speed according to the entire length of the actuator (ZS-C) manufactured in Preparative Example 4 under a condition of 42.3% humidity;

FIG. 13a is a graph of comparing rotation energy of the actuators (ZZ-C and ZS-C) manufactured in Preparative Examples 1 and 4 according to temperature, FIG. 13b is a graph showing the relationship between the rotation speed (closed figures) and rotation energy (open figures) of the actuator (ZS-C, Preparative Example 4) having different diameters according to a moment of inertia, FIG. 13c is a graph showing the temperature fluctuation, rotation angle and rotation energy of the actuator (ZS-C) manufactured in Preparative Example 4 according to time, and FIG. 13d is a graph showing the relationship between the rotation energy and the rotation speed according to the diameter of the actuator (ZS-C) manufactured in Preparative Example 4;

FIG. 14a is a graph of comparing the relationship between rotation energy and force measured after the actuator (ZS-C (Preparative Example 4)) and a type of the actuator (ZS-N) having only a twisted structure are heated on the whole, FIG. 14b is a graph of comparing the relationship between rotation energy and force measured after halves of the actuator (ZS-C (Preparative Example 4)) and a type of the actuator (ZS-N) having only a twisted structure are heated, FIG. 14c is a graph of comparing the relationship between rotation energy and force measured after halves of the actuator (ZZ-C (Preparative Example 1)) and a type of the actuator (ZZ-N) having only a twisted structure are heated, and FIG. 14d is a graph of comparing temperature fluctuations, rotation angles and a rotation speeds of the actuator (ZZ-C (Preparative Example 1)) and a type of the actuator (ZZ-N) having only a twisted structure according to time. In this case, the actuator (ZZ-C) manufactured in Preparative Example 1 which had a diameter of 27 μm and was stretched by 15% was used in FIG. 4d, and was indicated by black lines on the graph, and a type of the actuator (ZZ-N) having only a twisted structure having a diameter of 27 μm and including the position variation support having a load of 1.2 g was used, and indicated by red lines on the graph;

FIG. 15 is a diagram that demonstrates the energy harvesting device manufactured in Preparative Example 6. Here, the device includes the actuator having a 102 μm-long ZS-C structure (Preparative Example 4), and was manufactured using the three coils and a cylindrical neodymium magnetic material;

FIG. 16 is a graph showing the torsional rigidity and torsional modulus of elasticity of the ZS-C rotation-type actuator having a diameter of 27 μm according to temperature;

FIG. 17 is an actual image obtained by photographing a rotation-type actuator having a 2-ply structure, which has both an SZ coiled shape and a ZS coiled shape with respect to a joint of the rotation-type actuator having the 2-ply structure among rotation-type actuators having a 2-ply structure according to the present invention;

FIG. 18 is a cross-sectional view of an energy harvesting device according to still another embodiment of the present invention;

FIG. 19 is a diagram showing a harvesting result from the energy harvesting device manufactured in Preparative Example 7;

FIG. 20 is a graph showing results of measuring energy generated when an uncoiling/coiling period and a temperature fluctuation (19° C.) period of the rotation-type actuator were set to the same frequency of 5 Hz in the energy harvesting device manufactured in Preparative Example 7;

FIG. 21 is a graph showing results of measuring energy generated when an uncoiling/coiling period and a temperature fluctuation (8.2° C.) period of the rotation-type actuator were set to the same frequency of 5 Hz in the energy harvesting device manufactured in Preparative Example 7;

FIG. 22 shows examples of the structures which rotation-type actuators according to embodiments of the present invention may have;

FIG. 23 is a diagram showing a principle of the rotation-type actuator according to the present invention being actuated by generating a persistent temperature gradient in the rotation-type actuator using a temperature difference present in surrounding environments;

FIG. 24 is a diagram showing a manufacturing process of a polymer sheet in which at least one polymer fiber is aligned in a single direction;

FIG. 25 is a graph showing results of measuring a rotation speed (▪) and a rotation angle (□) of the rotation-type actuator (having a length of 12 cm and a diameter of 100 μm) manufactured at Preparative Example 8 which had a bottom portion whose temperature was held constant at 53° C. and thus had a temperature gradient;

FIG. 26 is a graph showing results of measuring a rotation speed (▪) of the rotation-type actuator (having a length of 12 cm and a diameter of 100 μm) manufactured in Preparative Example 8 when the temperature of the bottom portion was in a range of 40 to 60° C. in a state in which the difference in temperature between the top and bottom portions of the rotation-type actuator was held constant at 13° C.;

FIG. 27 is a graph showing results of measuring a rotation speed when a difference in temperature between the top and bottom portions of the rotation-type actuators having different shapes manufactured in Preparative Examples 8 to 12 was 10° C. and the temperature of the bottom portions was 52° C.;

FIG. 28 is a graph showing results of measuring rotation speeds and rotation energy for the rotation-type actuator manufactured in Preparative Example 8 which was tensile strained 0 to 50% with respect to the entire length before being fixed;

FIG. 29 is a graph showing results of measuring a rotation speed and rotation energy according to the moment of inertia after a paddle is attached to the center of the rotation-type actuator having different diameters manufactured in Preparative Example 8;

FIG. 30 is a graph showing a rotation speed and rotation energy of the rotation-type actuator manufactured in Preparative Example 8 according to the length of the rotation-type actuator;

FIG. 31 is a graph showing results of measuring a rotation speed at each cycle when the rotation-type actuator manufactured in Preparative Example 8 in which the temperature of the bottom portion is 53° C. and a difference in temperature between the bottom and top portions is 13° C. was actuated for a total of 8 hours;

FIG. 32 is graph showing a voltage (a black line) and an average temperature (a blue line) generated according to time in the energy harvesting device of Preparative Example 13 which includes a magnetic material between top and bottom portions of the rotation-type actuator manufactured in Preparative Example 8. In this case, the inset graph is a diagram showing one example of the energy harvesting device capable of converting heat energy into electrical energy;

FIG. 33 is a graph of measuring a voltage generated according to time in the energy harvesting device (having an average temperature of 46° C.) of Preparative Example 13 when a temperature gradient of 12° C. occurs through convection using a heat plate;

FIG. 34 is a graph showing results of measuring an electric force and voltage according to the resistance of the energy harvesting device of Preparative Example 13; and

FIG. 35 is a graph showing a voltage signal obtained by rectifying a voltage, which is generated from the energy harvesting device of Preparative Example 13 under the same conditions as shown in FIG. 33, using a connection rectifier. The inset drawing is a drawing of a rectifier circuit.

### BEST MODE

Hereinafter, various preferred aspects and embodiments of the present invention will be described in further detail.

One aspect of the present invention relates to a rotation-type actuator which includes a single fiber or a multi-fiber having a twisted structure, which is manufactured by rotating the fiber in the same direction or opposite directions. Here, the fiber is divided into top and bottom portions with respect to the center thereof, at least one of the top and bottom portions of the fiber is fixed, and the top and bottom portions of the fiber each independently have a twisted structure or a coiled shape as a chiral Z-type or chiral S-type structure.

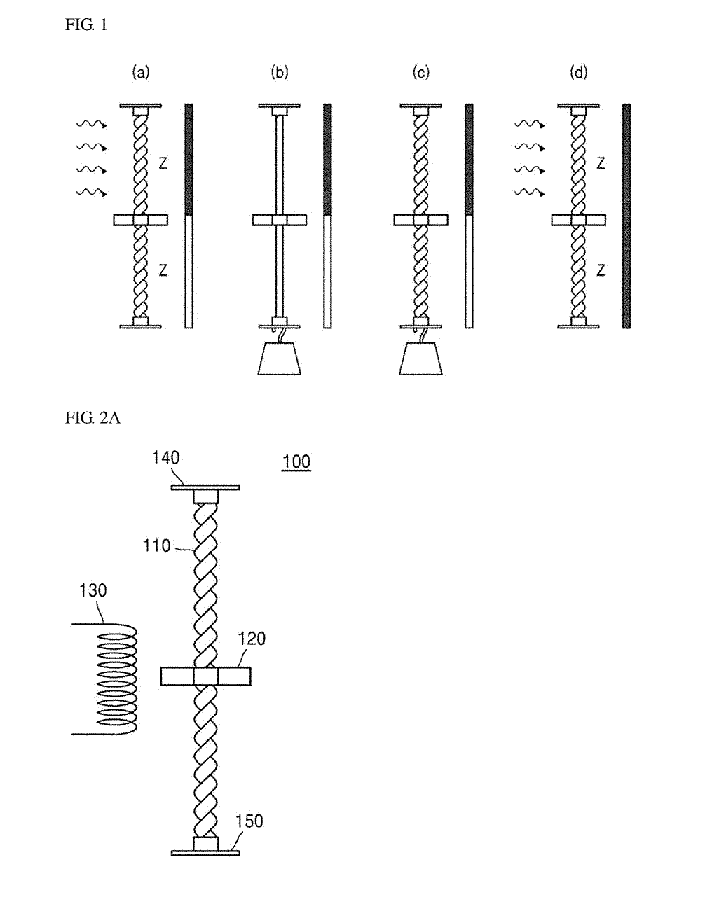

Examples of the structure which the rotation-type actuator may have will be described in further detail with reference to FIG. 1.

The rotation-type actuator may have two fixed end portions, and thus both top and bottom portions of the rotation-type actuator may have a shape (ZZ-C) coiled in a chiral Z type (FIG. 1a). Also, the rotation-type actuator may have two fixed end portions, and thus both top and bottom portions of the rotation-type actuator may have a shape (SS-C) coiled in a chiral S type. Optionally, the rotation-type actuator may have two fixed end portions, and thus both top and bottom portions of the rotation-type actuator may have a shape (ZS-C or SZ-C) chirally coiled in opposite directions (FIG. 1d).

Also, the rotation-type actuator may have only one fixed end portion, and thus both of the top and bottom portions of the rotation-type actuator may have a shape (ZZ-N) twisted in a chiral Z type (FIG. 1b). Also, the rotation-type actuator may have only one fixed end portion, and thus both of the top and bottom portions of the rotation-type actuator may have a shape (SS-N) twisted in a chiral S type. Optionally, the rotation-type actuator may have only one fixed end portion, and thus both of the top and bottom portions of the rotation-type actuator may have a shape (ZS-N or SZ-N) chirally twisted in opposite directions (not shown).

Also, the rotation-type actuator may have only one fixed end portion, and thus both of the top and bottom portions of the rotation-type actuator may have a shape (ZZ-C) coiled in a chiral Z type (FIG. 1c). Also, the rotation-type actuator may have only one fixed end portion, and thus both of the top and bottom portions of the rotation-type actuator may have a shape (SS-C) coiled in a chiral S type. Optionally, the rotation-type actuator may have only one fixed end portion, and thus both of the top and bottom portions of the rotation-type actuator may have a shape (ZS-C or SZ-C) chirally coiled in opposite directions.

In this case, in this specification, the coiled shape refers to a spring or coil shape. More specifically, the twisted structure and the coiled structure are distinguished from each other by the number of turns (turns/m) applied according to the diameter of the fiber. For example, when the fiber has a diameter of 27 μm, the fiber is coiled at 5,000 to 12,000 turns/m to form a twisted structure, and the fiber is coiled at 30,000 to 60,000 turns/m to form a coiled structure. For other fibers having different diameters, the numbers of turns required according to the structures are specifically listed in Table 1.

TABLE 1

| Fiber | | | Fiber with | Fiber with |
|---|---|---|---|---|
| diameter | | Single | coiled | twisted |
| (μm) | | fiber | structure | structure |
| 23 | Number of turns | 0 | 10,000 | 56,000 |
| | (turn/m) | | | |
| | Contraction length (%) | 0 | 16.5 | 80 |
| 80 | Number of turns | 0 | 3,770 | 20,000 |
| | (turn/m) | | | |
| | Contraction length (%) | 0 | 14.1 | 75.1 |
| 106 | Number of turns | 0 | 3,000 | 15,000 |
| | (turn/m) | | | |
| | Contraction length (%) | 0 | 14.3 | 75.3 |
| 133 | Number of turns | 0 | 2,600 | 13,000 |
| | (turn/m) | | | |
| | Contraction length (%) | 0 | 14.4 | 75 |

In the structure of the rotation-type actuator, a position variation support is provided at an unfixed end portion. The structure having two fixed end portions serves to prevent translational displacement and rotation in which a structure is untwisted when the temperature rises, and the structure provided with the position variation support serves to permit translational displacement but prevent rotation in which the structure is untwisted when the temperature rises.

That is, when both of the top and bottom portions of the rotation-type actuator are fixed, the rotation-type actuator has a rotating force due to the contraction or expansion of the rotation-type actuator caused by a temperature fluctuation. On the other hand, when only one of the top and bottom portions of the rotation-type actuator is fixed and the position variation support is provided at the other one, the rotation-type actuator has a change in rotating force and length due to the contraction or expansion of the rotation-type actuator caused by the temperature fluctuation.

When both of the top and bottom portions of the rotation-type actuator are fixed, the rotation-type actuator may be fixed after the rotation-type actuator is tensile strained 1 to 25% before being fixed, based on the total length of the rotation-type actuator. In this case, when both of the top and bottom portions are fixed after the rotation-type actuator is tensile strained, a sufficient distance between coils of the rotation-type actuator is formed. Accordingly, when expansion of the rotation-type actuator is caused due to an increase in temperature, less friction between the coils may be generated, and the rotation-type actuator may absorb a larger amount of heat due to an increase in the surface area of the rotation-type actuator, thereby improving heat conversion efficiency and preventing the loss of a rotating force caused by the friction.

When only one of the top and bottom portions of the rotation-type actuator is fixed, a change in length according to temperature may be in a range of 5 to 30%, based on the total length of the rotation-type actuator.

Therefore, since the rotation-type actuator has varying characteristics, such as a rotation angle or a rotation speed, caused by the temperature fluctuation depending on the respective structures, it is preferable to properly select one from the structures according to a desired purpose of use.

The rotation-type actuator according to the present invention rotates depending on the temperature fluctuation. The rotation-type actuator responds more immediately to the temperature fluctuation in an external environment around the actuator. In this case, the external environment of the actuator providing the temperature fluctuation is not particularly limited, and may be preferably a gas or a liquid.

Also, when the rotation-type actuator is exposed to an environment in which temperature rises, the actuator has a rotating force while a coiled structure or a twisted structure of the actuator is untwisted. When the temperature of the environment around the rotation-type actuator is lowered from the increased temperature, the rotation-type actuator has a rotating force in a direction opposite to the above direction while the untwisted coiled structure or twisted structure of the rotation-type actuator is twisted again. When the temperature of the environment around the rotation-type actuator rises, the heating/cooling cycle is repeated.

In this way, the rotation-type actuator may be actively cooled since heat energy is converted into mechanical energy by the rotation-type actuator instead of passively dissipating the heat energy, thereby cooling the rotation-type actuator.

That is, the rotation-type actuator may provide 100 to 200,000 rpm when the rotation-type actuator undergoes a temperature fluctuation amount ranging from 1 to 150° C.

Also, the rotation-type actuator is characterized by still providing a high rotation speed (100 to 200,000 rpm) without being irreversibly altered even when the heating/cooling cycle is repeated 300,000 times or more.

A power density of 5,000 to 15,000 W per 1 kg is provided by the rotation-type actuator. In this case, such a power density is approximately 40 times higher than that of a generally used electric motor (approximately 300 W/kg). Accordingly, it can be seen that the rotation-type actuator according to the present invention also has excellent electrical characteristics.

The fiber is not limited as long as the fiber is a polymer material such as nylon, shape-memory polyurethane, polyethylene, rubber, etc. More preferably, the fiber may include any one selected from the group consisting of nylon, shape-memory polyurethane, polyethylene and rubber, and most preferably nylon.

However, although the ZS-C structure is often applied to a fiber using conventional CNTs, the fiber having such a structure has a drawback in that the fiber is not actuated because the fiber is irreversibly altered at a high temperature at which the fiber has a high mechanical load. As a result, the fiber has limitations in being applied to the rotation-type actuator. However, in the present invention, since a polymer material, that is, any one selected from the group consisting of nylon, shape-memory polyurethane, polyethylene, rubber, etc. is used as the fiber, the fiber may maintain a reversible structure, in which an actuator in a ZS-C shape is untwisted and retwisted even at a high temperature, for a long period of time and is applicable in various fields due to high durability and a long service life. That is, the rotation-type actuator having such a structure in which any one of nylon, shape-memory polyurethane, polyethylene, and rubber is used as the polymer material provides a reversible rotational motion in which the fiber returns to an original shape even when the fiber is deformed at a high or low temperature unlike the conventional actuators.

The average diameter of the fiber is not particularly limited, but may be preferably greater than or equal to 10 nm, and more preferably in a range of 10 nm to 300 μm.

Also, the average diameter of the rotation-type actuator in which the fiber has a shape coiled in a chiral Z or S type varies depending on the average diameter of the fiber, and is not particularly limited, but may be preferably greater than or equal to 1 μm, and more preferably in a range of 1 to 150 μm. In this case, the rotation-type actuator has an increasing rotating force induced by a temperature fluctuation, depending on the diameter size thereof. As a result, when the diameter size falls out of this range, the efficiency of conversion of heat energy into rotation energy may be lowered.

The fiber preferentially has a twisted structure depending on the number of applied turns (turns/m), and then forms a coiled structure. In this case, it is desirable for the fiber to have a bias angle (torsional angle) of 20 to 60° in the twisted structure. Such torsion rearranges a configuration of the fiber into crystal and amorphous regions in a torsional direction. In this case, the rearranged crystal and amorphous structures have an influence on the performance of the rotation-type actuator of the present invention in response to an external temperature fluctuation.

Also, the weight of the magnetic material provided in the rotation-type actuator is not particularly limited because the weight of the magnetic material has no influence on the rotating force and kinetic energy of the rotation-type actuator. However, it is desirable that a magnetic material having a weight 1 to 1000 times heavier than the weight of the rotation-type actuator is installed and actuated. Specifically, the rotation-type actuator provides the constant rotating force and kinetic energy in response to the temperature fluctuation regardless of the weight of the magnetic material.

However, when the weight of the magnetic material provided in the rotation-type actuator increases, a rotation speed is reduced, but a twisting/untwisting cycle is lengthened. As a result, the final rotating force and kinetic energy are identical to those of the rotation-type actuator provided with a magnetic material having a smaller weight. Therefore, when the aforementioned characteristics of the rotation-type actuator according to the present invention are used, the rotation-type actuator has an advantage in that a rotation period of the rotation-type actuator may be controlled according to a heating/cooling cycle by adjusting the weight of the magnetic material.

Also, since the rotation-type actuator has constant kinetic energy produced per unit length, a larger amount of energy may be obtained by further extending the fiber. Therefore, the entire length of the rotation-type actuator is not particularly limited, but may be preferably in a range of 0.5 to 50 cm, more preferably 2 to 30 cm. However, since the rotation speed of the rotation-type actuator is proportional to the square root of the energy, the energy is increasingly proportional to the length of the rotation-type actuator when the length of the rotation-type actuator is greater than 15 cm, but an increase in speed is not significant. However, since the rotation-type actuator may be used in fields including various devices, clothing, etc., it is most desirable to properly select the length of the rotation-type actuator, depending on a desired place or purpose.

Also, the present invention provides a rotation-type actuator having a 2-ply structure using two strands of the rotation-type actuator. The rotation-type actuator is characterized by having a 2-ply structure consisting of two strands of the rotation-type actuator, and being actuated like one strand. The rotation-type actuator having such a 2-ply structure may have various structures according to a coiling direction.

That is, when two strands of the rotation-type actuator are coiled in a 2-ply structure, the two strands are coiled in a direction opposite to a coiling or twist direction of the respective rotation-type actuators to form a 2-ply structure.

More specifically, when the two strands of the rotation-type actuator have a chiral S-type structure, the rotation-type actuator may have an SZ coiled shape when the two strands are coiled in a Z type to form a 2-ply structure. When the two strands of the rotation-type actuator have a chiral Z-type structure, the rotation-type actuator may have a ZS coiled shape when the two strands are coiled in an S type to form a 2-ply structure. When the two strands of the rotation-type actuator are coiled in a direction opposite to a coiling or twist direction of such respective rotation-type actuators to form a 2-ply structure, service life characteristics in which the structure is maintained for a long period of time without being untwisted are improved.

FIG. 17 is an actual image obtained by photographing a rotation-type actuator having a 2-ply structure, which has both an SZ coiled shape and a ZS coiled shape with respect to a joint of the rotation-type actuator having the 2-ply structure among rotation-type actuators having a 2-ply structure according to the present invention. One example of the rotation-type actuator having the 2-ply structure is shown in FIG. 17, but the structure of the rotation-type actuator having the 2-ply structure is not limited thereto.

<Energy Harvesting Device>

Another aspect of the present invention relates to an energy harvesting device capable of converting heat energy into electrical energy using the rotation-type actuator which contracts or expands in response to the temperature fluctuation.

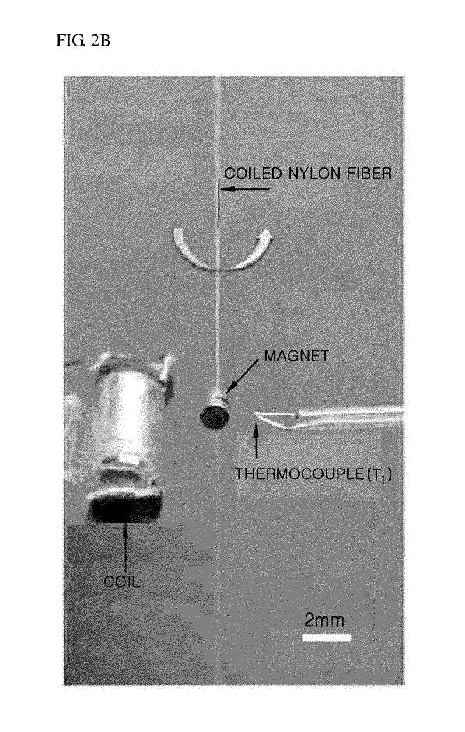

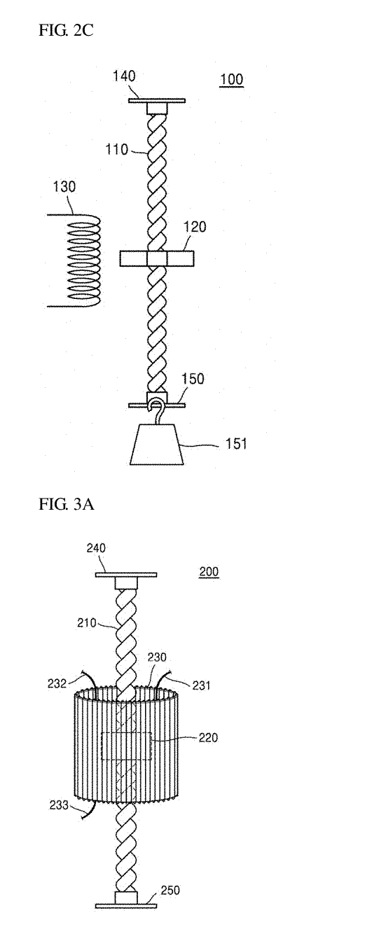

FIG. 2A is a cross-sectional view showing a configuration of an energy harvesting device according to a first embodiment of the present invention, and FIG. 2B is an actual image of the energy harvesting device according to the first embodiment of the present invention.

The energy harvesting device according to the first embodiment will be described in detail with reference to FIGS. 2A and 2B. The energy harvesting device includes the rotation-type actuator 110 contracting and expanding in response to a temperature fluctuation; at least one magnetic material 120 located inside the rotation-type actuator 110 and rotating as the actuator 110 rotates; and at least one coil 130 arranged spaced apart from the rotation-type actuator 110 and configured to generate electrical energy (magnetic force, electric current) through a change in magnetic flux passing through the interior of the coil as the magnetic material 120 rotates.

The energy harvesting device according to the present invention is a device configured to generate electrical energy from mechanical energy of the actuator 110 which is generated in response to a temperature fluctuation using Faraday's law of electromagnetic induction in which an electric current is induced by a relative motion between the magnetic material 120 and the coil 130. In this case, the actuator 110 having the structure as described above includes the magnetic material 120 located therein, and the energy harvesting device including the coil 130 arranged spaced apart from the magnetic material 120 included in the actuator 110 generates electricity through reciprocal interactions between the polarity of the static coil 130 and the polarity of the rotating magnetic material 120 as the actuator 110 rotates with contracting or expanding in response to a change in temperature. In this case, a top portion 140 and a bottom portion 150 of the actuator 110 may be fixed, or only one of the top portion 140 and the bottom portion 150 may be fixed. In this case, the other unfixed end portion of the actuator 110 may further include a position variation support 151.

The position variation support 151 is generally provided at a bottom portion of the actuator 110 to allow translational displacement of the actuator 110 and prevent rotation, thereby providing a more stable rotational motion to the actuator. That is, the position variation support 151 applies stress to the actuator 110 in a lengthwise direction to induce a change in length and tensile strain, thereby enabling the actuator 110 to have a structure which is easily modified in response to an external temperature fluctuation. Also, the position variation support 151 prevents untwisting and induces generation of a high rotating force in the magnetic material using the rotation of the actuator 110 caused during the temperature fluctuation.

As noted, when a galvanometer is connected to both end portions of the coil 130 to fix the coil 130 and the magnetic material 120 is allowed to move, the intensity of a magnetic flux (magnetic field) flowing through the coil 130 is changed in response to the movement of the magnetic material 120, and electricity is generated due to the law of electromagnetic induction in which an electric current is induced in the coil 130 by a change in the magnetic flux (magnetic field), that is, electricity is generated through reciprocal interactions between the polarity of the coil 130 and the polarity of the magnetic material 120.

More specifically, the coil 130 may be located a predetermined distance from one lateral surface of the actuator 110, as shown in FIG. 2.

The magnetic material 120 is not limited as long as the magnetic material 120 is a permanent magnet. However, a neodymium magnetic material is used in this exemplary embodiment. Also, the shape of the magnetic material 120 is not particularly limited, but may be preferably a rod shape or a cylindrical shape in which NS poles are arranged at left and right sides.

Since the weight of the magnetic material 120 serves as an important factor in adjusting a period of an uncoiling/coiling cycle in response to a temperature fluctuation of the rotation-type actuator 110 in the energy harvesting device, the weight of the magnetic material 120 is preferably 10 to 1000 times higher than that of the rotation-type actuator 110. When the weight of the magnetic material 120 falls out of this range, a decrease in a cyclic period, a rotation speed and the number of turns of the rotation-type actuator 110 is caused, resulting in a relative decrease in energy conversion efficiency with respect to the external temperature fluctuation.

The rotation-type actuator preferably has a length of 1 to 20 cm.

Also, a spacing between the magnetic material 120 and the coil 130 is preferably 1 mm. In this case, when the spacing is less than 1 mm, a rotating force of the magnetic material may be lowered due to the coil. Electrical energy may be induced within a range of the magnetic field of the magnetic material. On the other hand, when the spacing is greater than 1 mm, the magnetic flux in the coil 130 may be lost while a change in magnetic flux is induced by the magnetic material 120, resulting in lowered energy conversion efficiency.

A component that opens or closes in response to a temperature may be added to the energy harvesting device of the present invention so that the device is very easily attached to narrow places (for example, pipes, etc.) in which high-temperature heat is generated, or sites in which a hot wind blows steadily.

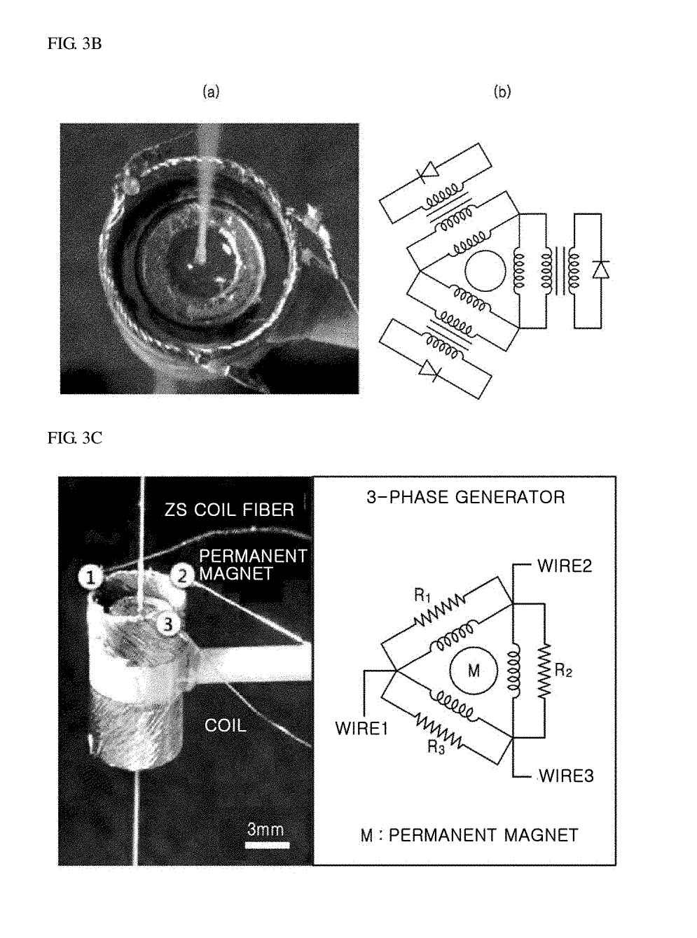

Hereinafter, an energy harvesting device according to a second embodiment will be described with reference to FIG. 3.

FIGS. 3A, 3B, and 3C is are a cross-sectional view of an energy harvesting device according to a second embodiment of the present invention, an image obtained by photographing the energy harvesting device viewed from the above, and an image obtained by photographing the energy harvesting device viewed from the side.

The energy harvesting device according to the second embodiment of the present invention generally has a similar configuration, compared to the energy harvesting device according to the first embodiment, but is different in that a coil is installed to surround a magnetic material 220 included in an actuator 210, as shown in FIG. 3A. In particular, three components of the coil 230 are provided to surround the magnetic material 220 while being located a predetermined distance from the magnetic material 220 provided in the actuator 210.

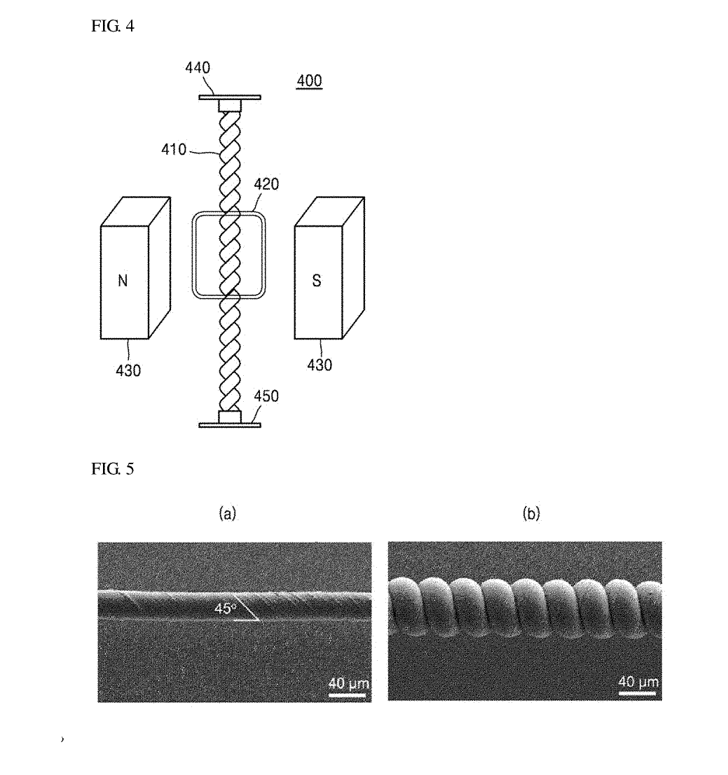

Hereinafter, an energy harvesting device according to a third embodiment will be described with reference to FIG. 4.

The energy harvesting device according to the third embodiment of the present invention generally has a similar configuration, compared to the energy harvesting devices according to the first and second embodiments, but is different in that the energy harvesting device includes a rotation-type actuator 410 contracting or expanding in response to a temperature fluctuation; at least one coil 420 located inside the rotation-type actuator 410 and rotating as the actuator 410 rotates; and at least one magnetic material 430 arranged spaced apart from the rotation-type actuator 410 and configured to generate electrical energy (magnetic force, electric current) through a change in magnetic flux passing through the interior of the coil as the magnetic material 420 rotates.

The magnetic material 430 is not particularly limited as long as the magnetic material 430 is a permanent magnet. However, the magnetic material 430 may be more preferably in a rod shape having N and S poles. In this case, an N-pole magnet and an S-pole magnet may be installed at left and right sides with respect to the rotation-type actuator 410, and may be arranged spaced apart from the coil 420.

Still another aspect of the present invention relates to an energy harvesting device according to a fourth embodiment which is capable of converting heat energy into potential energy, followed by converting potential energy into electrical energy using a rotation-type actuator which is fixed in a horizontal axis and contracts or expands in response to a temperature fluctuation. Hereinafter, the energy harvesting device according to the fourth embodiment will be described with reference to FIG. 18.

FIG. 18 is a cross-sectional view showing a configuration of an energy harvesting device according to a fourth embodiment of the present invention.

The energy harvesting device according to the fourth embodiment will be described in detail with reference to FIG. 18. The energy harvesting device includes a rotation-type actuator 510 having both end portions fixed on a horizontal axis and contracting or expanding in response to a temperature fluctuation; an elevation unit 520 provided at a central point in the rotation-type actuator 510; at least one magnetic material 530 provided below the elevation unit 520 and coupled to the elevation unit 520 to have a change in location as the rotation-type actuator 510 rotates; and at least one coil 540 configured to generate an electric field through the up-down movement of the magnetic material 530.

The energy harvesting device according to the fourth embodiment may convert rotation energy of the rotation-type actuator 510, which is generated in response to the temperature fluctuation, into potential energy using the elevation unit 520, and may generate electrical energy from the potential energy using Faraday's law of electromagnetic induction in which an electric current is induced by a relative motion between the magnetic material 530 and the coil 540.

However, even when the energy harvesting device does not include a unit (for example, the coil 540) configured to convert the potential energy of the magnetic material 530 into electrical energy as described above, the rotation energy in the rotation-type actuator 510 which is actuated by heat may be converted into useful work such as potential energy. However, by way of one example, an energy harvesting device including the rotation-type actuator 510 fixed on a horizontal axis and further including the magnetic material 530 and the coil 540 to generate electrical energy from the rotation-type actuator 510 will be described in the present invention.

That is, in the energy harvesting device according to the fourth embodiment, the rotation-type actuator 510 rotates while contracting or expanding in response to a change in temperature, and thus the magnetic material 530 coupled to the elevation unit 520 moves up and down (moves in a vertical axis direction) as the elevation unit 520 connected to a central point of the rotation-type actuator 510 rotates. This indicates that the heat energy is converted into mechanical (rotation or potential) energy by the rotation-type actuator according to the present invention.

As the magnetic material 530 moves up and down, a change in magnetic flux passing through the coil 540 may be induced by the relative motion between the magnetic material 530 and the coil 540 to generate electrical energy.

The coil 540 is not particularly limited as long as the coil 540 is in a position to generate an electric field through the up-down movement of the magnetic material 530. However, the coil 540 may be preferably provided at top, bottom and lateral surfaces of the magnetic material 530, or may be in a cylindrical structure surrounding a lateral surface of the magnetic material 530.

When the coil 540 is in a cylindrical structure surrounding the lateral surface of the magnetic material 530, a relative motion between the magnetic material 530 and the fixed cylindrical coil 540 is caused during the up-down movement of the magnetic material 530 to induce a change in magnetic flux passing through the coil 540, thereby generating electrical energy.

The elevation unit 520 is not particularly limited, but may be preferably a pulley.

An up-down movement distance of the magnetic material 530, that is, a location change distance of the magnetic material 530 in a vertical axis direction is preferably in a range of 0.1 to 3 cm.

The magnetic material 530 is not particularly limited as long as the magnetic material 530 is a permanent magnet, but may be more preferably in a rod shape having N and S poles, or in a cylindrical shape.

Meanwhile, various pyroelectric materials or piezoelectric materials have been developed in the prior art to convert heat energy present in external environments into mechanical energy or electrical energy. However, the aforementioned pyroelectric materials or piezoelectric materials are preferentially required to perform a manufacturing process for inducing polarization in the pyroelectric materials or piezoelectric materials to generate energy. This is generally a complicated process of applying a high voltage (10 mV/cm) to these materials or stretching the materials at a high temperature to induce crystallization of the materials. However, this process has a drawback in that it should be carried out in an elaborate manner.

Also, the actuator using the pyroelectric materials or piezoelectric materials is actuated when the actuator should have a high temperature fluctuation required to convert heat energy into mechanical energy or electrical energy and should be repeatedly heated and cooled. Therefore, since the actuator is actuated only at a place in which a repeated heating/cooling cycle is provided in an intentional manner, or a site in which a high temperature fluctuation generally occurs, etc., it is difficult to convert heat energy into mechanical energy in a general environment.

Other hybrid yarn or carbon nanotube yarn may be actuated at room temperature when an impregnated material has a low melting temperature (Tₘ), but an actuating force of the hybrid yarn or carbon nanotube yarn may be significantly lowered. Therefore, the hybrid yarn or carbon nanotube yarn has a very low efficiency in generating energy from a general environment. That is, various types of yarn developed in the prior art have a problem in that the yarn has very poor performance in being actuated in response to a temperature fluctuation in a general environment, or it is difficult to apply the yarn.

Accordingly, to solve the above problems, the prevent inventors have endeavored to manufacture a rotation-type actuator that can be actuated in response to a temperature difference in ordinary environments and actuated in a reversible, rapidly and continuous manner, and invented a rotation-type actuator having the same structure provided in the present invention.

One aspect of the present invention relates to a rotation-type actuator which includes at least one polymer fiber or a polymer sheet formed by aligning the polymer fiber in one direction. Here, the at least one polymer fiber or polymer sheet is divided into a top portion and a bottom portion with respect to the inner part thereof, at least one of the top and bottom portions of the at least one polymer fiber or polymer sheet is fixed, and the at least one polymer fiber or polymer sheet has a twisted or coiled shape, which is manufactured by rotating the top and bottom portions of the at least one polymer fiber or polymer sheet in the same direction or opposite directions. In this case, the rotation-type actuator is characterized by a difference in volume between a portion and the other portion of the rotation-type actuator when a temperature gradient occurs between the portion and the other portion of the rotation-type actuator, resulting in continuous rotation.

Specifically, the rotation of the rotation-type actuator may provide continuous rotation as the portion of the rotation-type actuator expands to be uncoiled and the other portion is recoiled when a temperature gradient between the portion and the other portion of the rotation-type actuator occurs.

In this case, the rotation-type actuator may be in a shape manufactured by rotating the top and bottom portions of the at least one polymer fiber or polymer sheet in the same direction. In this case, the shape of the rotation-type actuator may be the most preferred shape in converting heat energy into rotation energy in response to a temperature gradient since the shape of the rotation-type actuator exhibits excellent efficiency.

That is, the rotation-type actuator according to the present invention may generate a persistent flow of electric current when a temperature gradient in the rotation-type actuator continually occurs from the temperature fluctuation in surrounding environments, which makes it possible to persistently generate electrical energy from an irregular fluctuation in ambient temperature.

The present invention adopts a polymer material as a structure in which a temperature gradient in the rotation-type actuator continually occurs, thereby providing continuous rotation.

That is, when a temperature gradient between a portion and the other portion of the rotation-type actuator occurs, the portion of the rotation-type actuator contracts in a vertical direction, and the polymer fiber or polymer sheet expands in a twisted radial direction to be uncoiled, but the other portion other than the portion of the rotation-type actuator is relatively recoiled. Thereafter, rotation energy of the other portion that has been relatively excessively coiled is transferred to the portion so that the portion is recoiled. As a result, the rotation-type actuator according to the present invention may provide continuous rotation.

The rotation-type actuator according to the present invention may include at least one polymer fiber or a polymer sheet formed by aligning the polymer fiber in one direction to allow the at least one polymer fiber or polymer fiber to react sensitively to heat.

The polymer fiber may be a single fiber or a multi-fiber. In this case, the polymer fiber is not particularly limited as long as the polymer fiber is an elastic fiber having a shape memory effect. Preferably, the polymer fiber is characterized by including any one selected from the group consisting of nylon, polyurethane, polyethylene, and rubber. In this case, among the polymer fibers, since polyurethane has the thinnest diameter through an electrospinning process, the rotation-type actuator may have the fastest rotation speed when polyurethane is applied to the rotation-type actuator. Therefore, polyurethane is most preferably used as the polymer fiber in the rotation-type actuator according to the present invention.

Also, polyurethane is most preferred among the polymer fibers since polyurethane has high thermal expansion between a glass transition temperature (T_{g}) and a melting temperature (Tₘ), an excellent shape memory effect in returning to an original state in response to a temperature fluctuation, and a low glass transition temperature (T_{g}) of 25° C.

Also, it is most preferred to use a polymer sheet formed by aligning the polymer fiber in one direction rather than using only a polymer fiber consisting of the single fiber or multi-fiber. This is because a polymer that exhibits a change in volume while reacting sensitively to heat may be strained into a fiber having a micro-sized diameter through the electrospinning so that the fiber is manufactured into a well-aligned sheet, and the sheet may then be manufactured to be coiled to obtain a rotation-type actuator sensitive to heat.

The rotation-type actuator has a diameter of 0.5 to 200 μm. In this case, when the diameter of the rotation-type actuator is greater than 200 μm, energy conversion efficiency may be degraded due to a significant decrease in rotation speed. On the other hand, it is difficult to manufacture the rotation-type actuator whose diameter is less than 0.5 μm, and a complicated and sensitive process is required if possible.

Also, the rotation-type actuator may include at least one polymer fiber or a polymer sheet formed by aligning the polymer fiber in one direction. In this case, when the rotation-type actuator is formed of the polymer fiber, the polymer fiber may have a diameter of 0.5 to 200 μm. That is, when the diameter of the polymer fiber is less than 0.5 μm, it is difficult to manufacture the rotation-type actuator having a uniform diameter. On the other hand, when the diameter of the polymer fiber is greater than 200 μm, a rotation speed significantly drops.

Further, when the rotation-type actuator is a polymer sheet formed by aligning the polymer fiber in one direction, it is difficult to adjust polymer fibers so that the polymer fiber has a unidirectional orientation property when the diameter of the polymer fiber is less than 0.5 μm. On the other hand, when the diameter of the polymer fiber is greater than 200 μm, a rotation speed significantly drops. Also, since a rotation-type actuator having a diameter of 200 μm or more is manufactured, a rotation speed significantly drops. Therefore, the polymer fiber forming the polymer sheet preferably has a diameter of 1 to 10 μm.

Specifically, when the polymer sheet is used, coiling is applied to the polymer sheet formed by aligning the polymer fiber in one direction to manufacture a rotation-type actuator in a twisted or coiled shape. In this case, the polymer fiber forming the polymer sheet rearranges a polymer chain in a direction in which the coiling is applied.

As described above, when heat having a temperature higher than a glass transition temperature (T_{g}) of the polymer sheet is applied to the manufactured rotation-type actuator, the polymer fiber forming the polymer sheet behaves based on a shape memory effect in which the polymer fiber returns to an original state (a state before applying the coiling), and the polymer chain is coiled in a direction in which the entropy of the polymer chain increases.

That is, since a tendency of the polymer fiber to return to an original shape (a state before applying the coiling) is same as a tendency of the polymer chain whose entropy increases, that is, a tendency of the polymer chain to be coiled due to a shape memory effect, the rotation-type actuator may provide rotation with a higher stroke with the generation of a temperature gradient due to a ‘synergy effect’ of the aforementioned tendencies when the rotation-type actuator is heated.

Therefore, owing to the aforementioned effect, the polymer sheet rotates with a higher stroke than the rotation-type actuator manufactured by simply coiling the polymer fiber. As a result, the polymer sheet is preferably used rather than the polymer fiber.

Also, the rotation-type actuator including the polymer sheet having the unidirectional orientation property has a higher orientation property than the rotation-type actuator manufactured by simply coiling at least one polymer fiber, and thus may exhibit excellent torsional actuation since the rotation-type actuator has a wide surface area and is more sensitive to heat.

In the rotation-type actuator, the polymer sheet having a unidirectional orientation property is formed by subjecting a polymer solution to electrospinning so that at least one polymer fiber is aligned in one direction. This manufacturing process is shown in detail in FIG. 24.

Referring to FIG. 24, first of all, a polymer sheet in which at least one polymer fiber is aligned in a single direction may be manufactured through electrospinning. In this case, the polymer fiber preferably has a diameter of 0.5 to 200 μm. In this case, when the diameter of the polymer fiber is less than 0.5 μm, it is difficult to adjust polymer fibers to have a unidirectional orientation property. On the other hand, when the diameter of the polymer fiber is greater than 200 μm, a rotation speed significantly drops. Also, since a rotation-type actuator having a diameter of 200 μm or more is manufactured, a rotation speed significantly drops. Therefore, the polymer fiber forming the polymer sheet preferably has a diameter of 1 to 10 μm.

More specifically, a polymer fiber which constitutes the rotation-type actuator of the present invention, or a polymer sheet formed of the polymer fiber may be manufactured by subjecting a polymer spinning solution to electrospinning. In this case, a process of applying a high voltage to the polymer spinning solution to manufacture a fiber having a micro-sized diameter may be performed using methods known in the related art. Basically, an electric force using static electricity is used, and an effect of elongation with a mechanical force may also be exhibited using a device such as a motor in a collector. However, in the present invention, the fiber manufactured through the electrospinning is most preferred. This is because alignment of the polymer chain in the rotation-type actuator should be induced to manufacture the rotation-type actuator having a high rotation speed and excellent efficiency, and thus, when the rotation-type actuator is manufactured through electrospinning, the rotation-type actuator may be manufactured by orienting the polymer fibers having a micro-sized diameter in a single direction due to a pulling force caused by the electrospinning, and the alignment of the polymer chain may be simply and effectively induced using a method of applying coiling to the polymer fibers to realign the polymer fibers in a direction of the applied coiling, that is, a, spiral direction.

As described above, the polymer fiber constituting the polymer sheet oriented in a single direction may be manufactured through electrospinning to induce a polymer chain oriented in a single direction. Here, the single direction refers to a longitudinal axis direction of the rotation-type actuator, and such an orientation property is shown in FIG. 24.

Next, when the coiling is applied to the polymer sheet having such a unidirectional orientation property, the polymer sheet is coiled, and thus the polymer chain oriented in the polymer sheet is coiled in a coiling direction. That is, an orientation property of the polymer chain which has been oriented in the single direction is realigned according to a direction of the coiling which is applied to the polymer sheet, that is, a spiral direction.

Owing to the orientation property of the polymer chain formed in the polymer sheet of the present invention, when a temperature gradient occurs in the rotation-type actuator including the polymer sheet, since a tendency of the polymer chain having the orientation property to be coiled in a direction in which the entropy of the polymer chain increases and a tendency of the polymer chain which returns to an original shape (unaligned state) due to a shape memory effect appear in the same direction, a ‘synergy effect’ of the two tendencies occurs. Therefore, since more ideal actuation in which the rotation-type actuator contracts in a lengthwise direction and a volume of the rotation-type actuator expands is induced, the rotation-type actuator may provide higher rotation energy.

To allow the polymer fiber to have a unidirectional orientation property, the electrospinning is preferably performed under a condition of an applied voltage of 10 to 20 kV when a distance between a spinning nozzle and a collector is in a range of 5 to 30 cm.

A rotation-type actuator in a twisted or coiled shape may be manufactured by fixing top and bottom portions of the polymer fiber or polymer sheet to an electric motor and a support, respectively, and rotating the top and bottom portions of the polymer fiber or polymer sheet in the same direction or opposite directions. In this case, the rotation-type actuator is preferably manufactured by rotating the polymer fiber or polymer sheet at a twist number of 2,000 to 60,000 turns/m at a temperature greater than or equal to a glass transition temperature (T_{g}) of the polymer fiber or polymer sheet. By way of one example, the electrospinning is preferably performed at 30 to 60° C. when the polymer fiber or polymer sheet is polyurethane.

A temperature gradient between a portion and the other portion of the rotation-type actuator is not particularly limited as long as the temperature gradient is greater than or equal to 1° C. at which a rotation speed is provided. However, when the temperature gradient is preferably in a range of 3 to 30° C., an excellent rotation speed may be sufficiently provided.

In the present invention, the temperature gradient refers to a difference in temperature occurring in a direction in which heat is transferred from a certain point (a portion) to the other portion. Here, the certain point is referred to as a portion in the present invention.

Therefore, since the rotation-type actuator generates mechanical energy due to a temperature gradient, a length or area of a portion of the rotation-type actuator, which is a point having the highest temperature, is not particularly limited. However, a length ratio of the portion and the other portion of the rotation-type actuator may be particularly in a range of 0.1-1:1. In this case, a temperature gradient from the portion to the other portion of the rotation-type actuator, that is, a difference in temperature in a direction in which heat is transferred from the portion to the other portion of the rotation-type actuator occurs. As a result, the portion of the rotation-type actuator expands to be uncoiled and the other portion is recoiled, thereby providing continuous rotation.

When the rotation-type actuator is heated on the whole without generating a temperature gradient, rotation energy is not generated and only a change in length is caused. As a result, a rotating force is not provided when the rotation-type actuator is heated on the whole.

When a proportion of the length occupied by the portion is significantly higher than that of the other portion, that is, when the rotation-type actuator is heated on the whole, only reversible potential energy (a change in length) is simply provided, but rotation energy is not generated. Also, since the entire length is reduced only when the temperature is lowered again, it is not possible to provide reversible but continuous potential energy.

Also, the maximum temperature of the rotation-type actuator may be properly selected depending on the type of the polymer fiber or polymer sheet included in the rotation-type actuator, but is not particularly limited as long as the maximum temperature of the rotation-type actuator is preferably greater than or equal to a glass transition temperature (T_{g}) of the polymer fiber or polymer sheet. When the maximum temperature of the rotation-type actuator is preferably in a range of 20 to 80° C., a rotation speed may be provided. By way of one example, in the case of the rotation-type actuator manufactured by applying coiling to the polymer sheet in which the polyurethane fiber is oriented in one direction, the polyurethane has a glass transition temperature (T_{g}) of 30.6° C. Therefore, when the glass transition temperature (T_{g}) of the polyurethane is in a range of 30 to 80° C., a sufficient rotation speed may be provided. More preferably, the best rotation speed may be provided at 45 to 60° C.

A structure of the rotation-type actuator is shown in detail in FIG. 22. The structure of the rotation-type actuator will be described in further detail with reference to FIG. 22. The rotation-type actuator is divided into a top portion and bottom portion with respect to the inner part thereof, and rotation-type actuators having various shapes may be manufactured, depending on coiling directions of the top and bottom portions.

The rotation-type actuator is manufactured by coiling both of the top and bottom portions of the rotation-type actuator in the same direction (a Z or S type), as shown in FIGS. 22a, 22b and 22c, and the rotation-type actuator is manufactured by coiling the top and bottom portions of the rotation-type actuator in different directions (a chiral structure in which, when one end portion is in a Z type, the other end portion is in an S type), as shown in FIGS. 22d and 22e.

Also, the rotation-type actuator may be manufactured in a twisted shape obtained by twisting the top and bottom portions of the rotation-type actuator before a coil is formed (FIG. 22a), or manufactured in a coiled shape by further applying coiling to the twisted shape (FIGS. 22b, c, d and e).

In this case, in this specification, the term “twisted shape” or “coiled shape” refers to a shape manufactured by applying rotation (twisting) to a polymer fiber or polymer sheet constituting the rotation-type actuator using an electric motor, and thus is determined by rotations applied according to the diameter of the polymer fiber or polymer sheet, that is, the number of turns (turn/m) (hereinafter referred to as a ‘twist number’). More specifically, it can be seen that, when a twist number of 12,000 to 18,000 turns/m is applied to the polymer fiber having a diameter of 100 μm, the polymer fiber is manufactured in a twisted shape, whereas when an excessive twist number of 25,000 to 30,000 turns/m which exceeds a twist number of 18,000 turns/m is applied to the polymer fiber, the polymer fiber is manufactured in a coiled shape like a spring or coil further in the twisted shape. The twist numbers required in the case of other polymer fibers having different diameters is listed in detail in the following Table 2.

In this case, the rotation-type actuator is in a shape manufactured by rotating the top and bottom portions of the at least one polymer fiber or polymer sheet in the same direction. In this case, the shape of the rotation-type actuator is the most preferred shape in converting heat energy into rotation energy in response to a temperature gradient since the shape of the rotation-type actuator exhibits excellent efficiency.

Also, the rotation-type actuator may have a structure in which two end portions are fixed as shown in FIGS. 22a, 22b and 22d, or a structure in which one of the two end portions is fixed as shown in FIGS. 22c and 22e. In this case, a position variation support may be provided at the other unfixed end portion.

Specifically, in the case of the rotation-type actuator having two fixed end portions as described above, when a temperature gradient occurs in the rotation-type actuator, the rotation-type actuator prevents translational displacement such as up-down movement, that is, prevents the generation of potential energy, and a coiling structure of the rotation-type actuator is prevented from being excessively uncoiled to return to an irreversible state.

Also, in the case of the rotation-type actuator which has one fixed end portion and has the other unfixed end portion provided with a position variation support, when a temperature gradient occurs in the rotation-type actuator, the rotation-type actuator allows translational displacement such as up-down movement, that is, allows the generation of potential energy, but a coiling structure of the rotation-type actuator is prevented from being excessively uncoiled to return to an irreversible state.

That is, when both of the top and bottom portions of the rotation-type actuator are fixed, the rotation-type actuator has only rotation energy due to contraction or expansion of the rotation-type actuator caused by a temperature gradient. On the other hand, when only one of the top and bottom portions of the rotation-type actuator is fixed and a position variation support is provided at the other unfixed end portion, the rotation-type actuator has both rotation energy generated due to the contraction or expansion of the rotation-type actuator caused by the temperature gradient and potential energy generated by the up-down movement.

TABLE 2

| Diameter | | | | |
|---|---|---|---|---|
| (μm) of | | Single | | |
| polymer fiber | | fiber | Twisted shape | Coiled shape |
| 80 | Twist number | 0 | 22,000 | 30,000 |
| | (turn/m) | | | |
| 100 | Twist number | 0 | 18,000 | 25,000 |
| | (turn/m) | | | |
| 120 | Twist number | 0 | 9,000 | 15,000 |
| | (turn/m) | | | |

When both of the top and bottom portions of the rotation-type actuator are fixed, the rotation-type actuator preferably is fixed after the rotation-type actuator is tensile strained 10 to 60% before being fixed, based on the total length of the rotation-type actuator. This is because a sufficient distance between coils of the rotation-type actuator is formed when both of the top and bottom portions are fixed after the rotation-type actuator is strained in this range.

That is, when a temperature gradient occurs in the rotation-type actuator, a portion of the rotation-type actuator expands to rotate, thereby generating rotation energy. In this case, less friction between coils is generated due to a distance formed between the coils in the rotation-type actuator, and a larger amount of heat may be absorbed due to an increase in the surface area of the rotation-type actuator, thereby improving heat conversion efficiency and preventing the loss of a rotating force caused by the friction.

When only one of the top and bottom portions of the rotation-type actuator is fixed, a change in potential energy through up-down movement of the rotation-type actuator is caused upon generation of the temperature gradient. In this case, the change in potential energy results from a change in length of the rotation-type actuator. That is, the change in length of the rotation-type actuator may be in a range of 10 to 60%, based on the entire length of the rotation-type actuator.

Therefore, since the type of energy converted by the temperature gradient into potential energy or rotation energy and an amount of converted rotation energy, that is, a rotation angle, a rotation speed, etc. vary depending on the respective different structures of the rotation-type actuator, it is preferable to properly select one from the structures of the rotation-type actuator according to a desired purpose of use.

The rotation-type actuator according to the present invention is actuated depending on a difference in external temperature. The rotation-type actuator responds more immediately to a temperature difference in an external environment around the actuator. In this case, the external environment of the actuator providing the temperature difference is not particularly limited, but may be preferably a gas or a liquid.

The rotation-type actuator according to the present invention has a substantially similar rotation speed in two steps of untwisting and re-twisting unlike conventional various actuators enabling rotation-type actuation.

A swivel module using the rotation-type actuator according to the present invention may be calculated thorough the following [Equation 1] using torsional rigidity. Before the swivel module is calculated, a torsional oscillation period may be calculated thorough the following [Equation 2].

S=k_{Air}(1/(L_{Air,1})+2/(L_{Air,2})) [Equation 1]

In [Equation 1], k_{Air} represents a swivel module, and

L_{Air,1} and L_{Air,2} each independently represent a length at the same temperature.

t=2π(I/S)^{1/2} [Equation 2]

In [Equation 2], t represents a torsional oscillation period,

I represents a moment of inertia of a paddle, and

S represents a torsional rigidity.

<Principle of Rotation-Type Actuator>

The rotation-type actuator according to the present invention is a device configured to recover heat energy, which is wasted in surrounding environments, as kinetic energy or rotation energy. That is, the rotation-type actuator is characterized by being actuated in normal places of daily life in which a temperature fluctuation is insignificant, as well as spaces in heaters and coolers in which a temperature fluctuation intentionally or periodically occurs. That is, an insignificant difference in temperature in the air such as convection occurs in the places in which the temperature fluctuation is insignificant, and due to such temperature difference, the rotation-type actuator is then actuated due to a temperature difference, that is, a temperature gradient occurring between an inner portion and the other inner portion of the rotation-type actuator.

In the rotation-type actuator of the present invention, when a temperature gradient between the portion and the other portion of the rotation-type actuator occurs as described above, the portion of the rotation-type actuator contracts in a vertical direction, and the polymer fiber or polymer sheet expands in a twisted radial direction to be uncoiled, but the other portion other than the portion of the rotation-type actuator is relatively recoiled. Thereafter, rotation energy of the other portion that has been relatively excessively coiled is transferred to the portion so that the portion is recoiled. As a result, the rotation-type actuator according to the present invention may provide continuous rotation to convert heat energy in the air into mechanical energy such as potential energy or rotation energy.

When the temperature gradient between the portion and the other portion of the rotation-type actuator is greater than or equal to 1° C., an excellent rotation speed may be sufficiently provided. However, the temperature gradient may be preferably in a range of 3 to 30° C. to provide an excellent rotation speed.

Also, the maximum temperature of the rotation-type actuator may be properly chosen depending on the type of the polymer fiber or polymer sheet included in the rotation-type actuator, but is not particularly limited when the maximum temperature of the rotation-type actuator is preferably greater than or equal to a glass transition temperature (Tg) of the polymer fiber or polymer sheet. However, when the maximum temperature of the rotation-type actuator is preferably in a range of 20 to 80° C., a rotation speed may be provided. By way of one example, in the case of the rotation-type actuator manufactured by applying coiling to the polymer sheet in which the polyurethane fiber is aligned in one direction, the polyurethane has a glass transition temperature (T_{g}) of 30.6° C. As a result, when the maximum temperature is in a range of 30 to 80° C., a sufficient rotation speed may be provided. More preferably, the best rotation speed may be provided at 45 to 60° C.

Since the rotation-type actuator generates mechanical energy using a temperature gradient, a length or area of the portion of the rotation-type actuator, which is a point having the highest and lowest temperature, is not particularly limited. Specifically, however, a length ratio of the portion and the other portion of the rotation-type actuator may be in a range of 0.1-1:1. In this case, a temperature gradient from the portion to the other portion of the rotation-type actuator, that is, a difference in temperature in a direction in which heat is transferred from the portion to the other portion of the rotation-type actuator occurs.

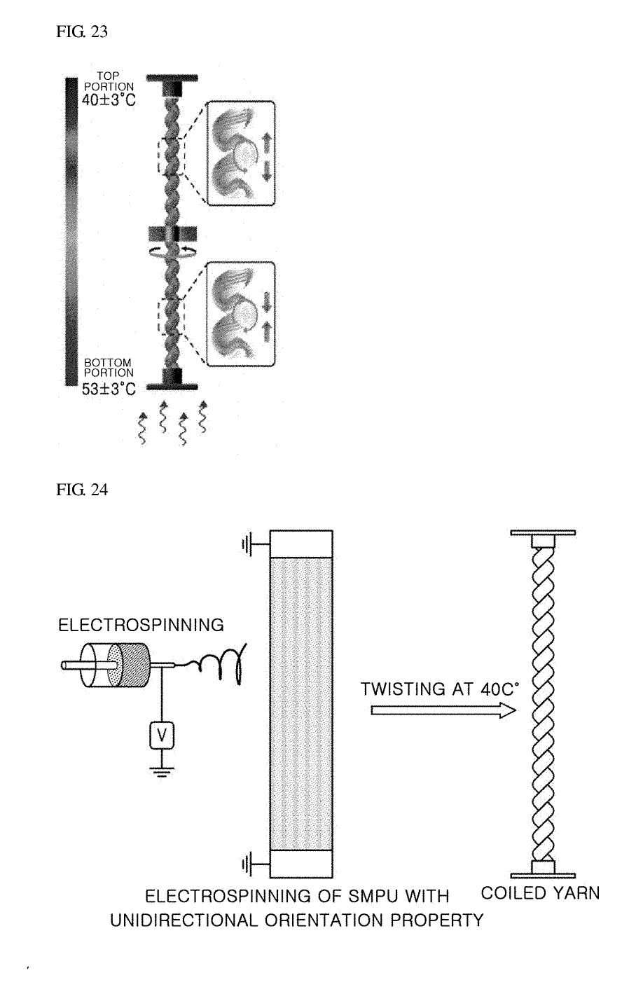

FIG. 23 is a diagram showing a principle of the rotation-type actuator according to the present invention being actuated by generating a persistent temperature gradient in the rotation-type actuator using a temperature difference present in surrounding environments. In this case, the rotation-type actuator is in a shape coiled in the same direction so that both end portions of the rotation-type actuator are not fixed and position variation supports are attached to the both end portions of the rotation-type actuator. Here, a process of uncoiling the rotation-type actuator through rotation due to the occurrence of a temperature gradient from 40° C. to 53° C. is shown.

As shown in FIG. 23, when the actuation occurs in a direction of the polyurethane sheet due to a persistent temperature gradient, the bottom portion of the polyurethane sheet is uncoiled, and the top portion is relatively coiled accordingly.

That is, a difference in ambient temperature occurs due to convection without heating or cooling the rotation-type actuator according to the present invention at an ambient temperature. As a result, as a temperature gradient occurs in the rotation-type actuator of the present invention, high rotation energy and potential energy caused by the up-down movement may be provided to each of the top and bottom portions of the rotation-type actuator.

<Energy Harvesting Device>

Yet another aspect of the present invention relates to an energy harvesting device capable of converting heat energy into electrical energy using the rotation-type actuator providing continuous rotation due to the temperature gradient.

FIG. 2 is a cross-sectional view showing a configuration of an energy harvesting device according to one exemplary embodiment of the present invention.

The energy harvesting device according to one exemplary embodiment will be described in detail with reference to FIG. 2. The energy harvesting device includes the rotation-type actuator 110 configured to provide continuous rotation due to a temperature gradient; at least one magnetic material 120 located inside the rotation-type actuator 110 and rotating as the actuator 110 rotates; and at least one coil 130 arranged spaced apart from the rotation-type actuator 110 and configured to generate electrical energy (magnetic force, electric current) through a change in magnetic flux passing through the interior of the coil as the magnetic material 120 rotates.

The energy harvesting device according to the present invention is directed to a device configured to generate electrical energy from mechanical energy of the rotation-type actuator 110 which is generated in response to a temperature gradient using Faraday's law of electromagnetic induction in which an electric current is induced by a relative motion between the magnetic material 120 and the coil 130. In this case, the rotation-type actuator 110 having the structure as described above includes the magnetic material 120 located therein, and the energy harvesting device including the coil 130 arranged spaced apart from the magnetic material 120 included in the rotation-type actuator 110 causes continuous rotation since a difference in volume between the portion and the other portion of the rotation-type actuator occurs when a temperature gradient between a portion and the other portion of the rotation-type actuator 110 occurs in an external environment having a temperature difference such as convection. More specifically, the rotation of the rotation-type actuator may provide continuous rotation as the portion of the rotation-type actuator expands to be uncoiled and the other portion is recoiled, thereby generating electricity through reciprocal interactions between the polarity of the static coil 130 and the polarity of the rotating magnetic material 120. In this case, the top portion 140 and the bottom portion 150 of the actuator 110 may also be fixed, or only one of the top portion 140 and the bottom portion 150 may be fixed. In this case, the other unfixed end portion may further include a position variation support 151.

The position variation support 151 is generally provided at a lower end of the rotation-type actuator 110 to allow translational displacement of the rotation-type actuator 110, and preventing irreversible untwisting of the rotation-type actuator 110, thereby providing a more stable rotational motion to the actuator. That is, the position variation support 151 applies stress to the rotation-type actuator 110 in a lengthwise direction to induce a change in length and strain, thereby enabling the rotation-type actuator 110 to have a structure which is easily modified in response to a temperature gradient generated from a difference in external temperature. Also, the continuous rotation of the rotation-type actuator 110 caused by the temperature gradient prevents untwisting of the position variation support 151 and induces the generation of a high rotating force in the magnetic material.

As noted, when a galvanometer is connected to both end portions of the coil 130 to fix the coil 130 and the magnetic material 120 is allowed to move, the intensity of a magnetic flux (magnetic field) flowing through the coil 130 is changed in response to the movement of the magnetic material 120, and electricity is generated due to the law of electromagnetic induction in which an electric current is induced in the coil 130 by a change in the magnetic flux (magnetic field), that is, electricity is generated through reciprocal interactions between the polarity of the coil 130 and the polarity of the magnetic material 120.

More specifically, the coil 130 may be located a predetermined distance from one lateral surface of the rotation-type actuator 110, as shown in FIG. 2.

The magnetic material 120 is not limited as long as the magnetic material 120 is a permanent magnet. However, a neodymium magnetic material is used in this exemplary embodiment. Also, the shape of the magnetic material 120 is not particularly limited, but may be preferably a rod shape or a cylindrical shape in which NS poles are arranged at left and right sides.

Since the weight of the magnetic material 120 serves as an important factor in adjusting rotation speed and rotation energy in response to a temperature gradient of the rotation-type actuator 110 in the energy harvesting device, the weight of the magnetic material 120 is preferably 1 to 1000 times higher than that of the rotation-type actuator 110. When the weight of the magnetic material 120 falls out of this range, a decrease in rotation speed and rotation energy of the rotation-type actuator 110 is caused, resulting in a relative decrease in efficiency of converting a temperature gradient of the rotation-type actuator 110 generated with respect to a difference in external temperature into mechanical energy. In particular, when the rotation-type actuator 110 includes polyurethane, the rotation-type actuator 110 has a rapid rotation speed but low rotation energy. Therefore, the weight of magnetic material 120 is preferably 1 to 10 times higher than that of the rotation-type actuator 110 to convert the mechanical energy into electrical energy while maintaining an excellent rotation speed.

The rotation-type actuator 110 preferably has a length of 1 to 20 cm.

Also, a spacing between the magnetic material 120 and the coil 130 is preferably 1 mm. In this case, when the spacing is less than 1 mm, a rotating force of the magnetic material may be lowered due to the coil. Electrical energy may be induced within a range of the magnetic field of the magnetic material. On the other hand, when the spacing is greater than 1 mm, the magnetic flux in the coil 130 may be lost while a change in magnetic flux is induced by the magnetic material 120, resulting in lowered energy conversion efficiency.

A component that opens or closes in response to a temperature is added to the energy harvesting device of the present invention so that the component is very easily attached to narrow places (for example, pipes, etc.) in which high-temperature heat is generated, or sites in which a hot wind blows steadily.

The energy harvesting device may further include a plate 170 provided with an opening/closing port; and a pin 160 connected to the actuator configured to control opening and closing of the opening/closing port. The plate 170 provided with the opening/closing port is located at an end portion of the bottom portion 150 of the rotation-type actuator 110, and the pin 160 is fixed at any position of the bottom portion 150 of the rotation-type actuator.

Hereinafter, an energy harvesting device according to another exemplary embodiment will be described with reference to FIG. 3.

FIG. 3 is a cross-sectional view (A) of an energy harvesting device according to another exemplary embodiment of the present invention, and an image (B) obtained by photographing the energy harvesting device, as viewed from the above.

The energy harvesting device according to another exemplary embodiment of the present invention generally has a similar configuration, compared to the energy harvesting device according to one exemplary embodiment as shown in FIG. 2, but is different in that a coil 230 is installed to surround the magnetic material 220 included in the rotation-type actuator 210, as shown in FIG. 3A. In particular, three components, that is, three coils 230 are connected to surround the magnetic material 220 provided in the rotation-type actuator 210, and units 231, 232 and 233 configured to connect the respective coils 230 to external devices extend from the coils 230. A structure of the coil 230 is more specifically shown in FIG. 6B.

Also, the coil 230 is provided to surround the magnetic material 220 while being located a predetermined distance from the magnetic material 220 provided in the actuator 210.

Hereinafter, an energy harvesting device according to still another exemplary embodiment will be described with reference to FIG. 4.

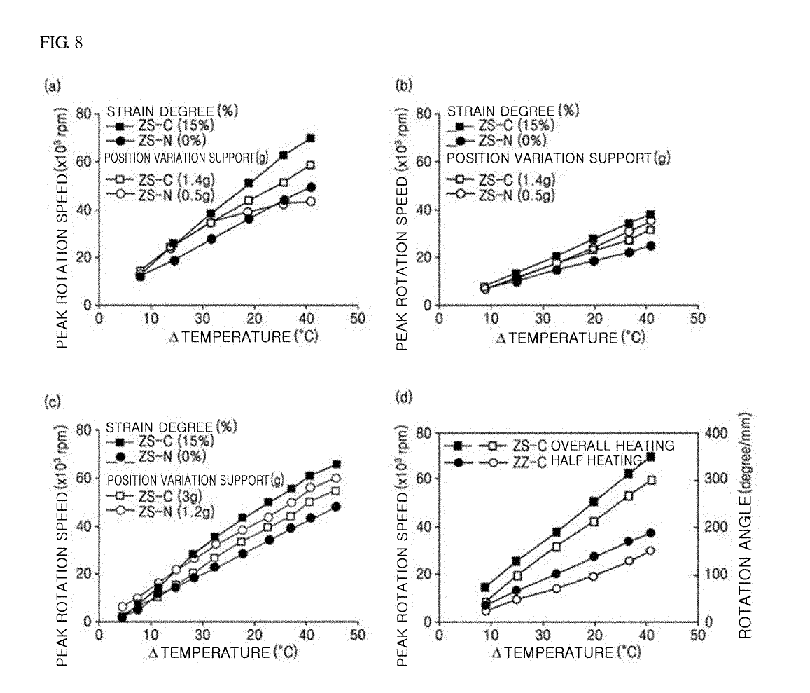

The energy harvesting device according to still another exemplary embodiment of the present invention generally has a similar configuration, compared to the energy harvesting device according to one exemplary embodiment as shown in FIG. 2, but is different in that the energy harvesting device includes a rotation-type actuator 410 configured to provide continuous rotation due to a temperature gradient; at least one coil 420 located inside the rotation-type actuator 410 and rotating as the rotation-type actuator 410 rotates; and at least one magnetic material 430 arranged spaced apart from the rotation-type actuator 410 and configured to generate electrical energy (magnetic force, electric current) through a change in magnetic flux passing through the interior of the coil as the coil 420 rotates, as shown in FIG. 8.

The magnetic material 430 is not particularly limited as long as the magnetic material 430 is a permanent magnet. However, the magnetic material 430 may be more preferably in a rod shape having N and S poles. In this case, an N-pole magnet and an S-pole magnet may be installed at left and right sides with respect to the rotation-type actuator 410, and may be arranged spaced apart from the coil 420.

Yet another aspect of the present invention relates to an energy harvesting device according to yet another exemplary embodiment capable of converting heat energy into potential energy, followed by converting the potential energy into electrical energy using the rotation-type actuator which is fixed on a horizontal axis and provides continuous rotation due to a temperature gradient. Hereinafter, the energy harvesting device according to yet another exemplary embodiment will be described with reference to FIG. 18.

FIG. 18 is a cross-sectional view showing a configuration of the energy harvesting device according to yet another exemplary embodiment of the present invention.

The energy harvesting device according to yet another exemplary embodiment will be described with reference to FIG. 18. The energy harvesting device includes a rotation-type actuator 510 having both end portions fixed on a horizontal axis and configured to provide continuous rotation due to a temperature gradient; an elevation unit 520 provided at a central point in the rotation-type actuator 510; at least one magnetic material 530 provided below the elevation unit 520 and coupled to the elevation unit 520 to have a change in location as the rotation-type actuator 510 rotates; and at least one coil 540 configured to generate an electric field through up-down movement of the magnetic material 530.

The energy harvesting device having the aforementioned configuration according to yet another exemplary embodiment may convert continuous rotation energy of the rotation-type actuator 510, which is generated in response to the temperature gradient, into potential energy using the elevation unit 520, and may generate electrical energy from the potential energy using Faraday's law of electromagnetic induction in which an electric current is induced by a relative motion between the magnetic material 530 and the coil 540.

However, even when a unit configured to convert potential energy of the magnetic material 530 into electrical energy, for example, such as the coil 540, is not included as described above, the rotation energy in the rotation-type actuator 510 actuated by heat may be converted into useful work energy such as potential energy. However, as an example in the present invention, an energy harvesting device which includes the rotation-type actuator 510 fixed in a horizontal axis and hence further includes the magnetic material 530 and the coil 540 to generate electrical energy will be described.

That is, the energy harvesting device having the aforementioned configuration may provide continuous rotation as the portion of the rotation-type actuator expands to be uncoiled and the other portion is recoiled when a temperature gradient between the portion and the other portion of the rotation-type actuator 510 occurs due to a difference in external temperature. As a result, the magnetic material 530 coupled to the elevation unit 520 moves up and down (moves in a vertical axis direction) as the elevation unit 520 coupled to a central point of the rotation-type actuator 510 rotates. This means that the heat energy is converted into mechanical (rotation or potential) energy by the rotation-type actuator according to the present invention.

The rotation-type actuator is characterized in that, as the magnetic material 530 moves up and down, a change in magnetic flux passing through the coil 540 is induced by a relative motion between the magnetic material 530 and the coil 540 to generate electrical energy.

The position of the coil 540 is not particularly limited as long as the coil 540 is provided at a position at which an electric field may be generated through the up-down movement of the magnetic material 530. However, the coil 540 is preferably provided at top, bottom and lateral surfaces of the magnetic material 530, or may be in a cylindrical structure surrounding a lateral surface of the magnetic material 530.

When the coil 540 is in a cylindrical structure surrounding a lateral surface of the magnetic material 530, a relative motion between the magnetic material 530 and the fixed cylindrical coil 540 may occur during up-down movement of the magnetic material 530 to induce a change in magnetic flux passing through the coil 540, thereby generating electrical energy.

The elevation unit 520 is not particularly limited as long as the elevation unit 520 is a device capable of converting rotation energy into potential energy, but may be preferably a pulley.

An up-down movement distance of the magnetic material 530, that is, a location change distance of the magnetic material 530 in a vertical axis direction is preferably in a range of 0.1 to 3 cm.

The magnetic material 530 is not particularly limited as long as the magnetic material 530 is a permanent magnet, but may be more preferably in a rod shape having N and S poles, or in a cylindrical shape.

### MODE FOR INVENTION

Hereinafter, the present invention will be described in further detail with reference to examples thereof. However, it should be interpreted that the following examples and equivalents thereof are not intended to reduce or limit the scope and contents of the present invention. Also, it will be apparent that the present invention in which specific experimental results are not provided can be easily put into practice by a person having ordinary skill in the related art, based on the disclosure of the present invention including the following examples. However, it should be understood that such modifications and changes are intended to be encompassed in the appended claims.

### PREPARATIVE EXAMPLES 1 TO 4

### Rotation-Type Actuator

One end of a nylon 6,6 fiber precursor was attached to a motor, and a rod is connected to the other end of the precursor to fix the other end of the precursor so as to apply a constant force and prevent uncoiling of rotation. A force applied during coiling has an influence on a rotation angle or a spring index of the rotation-type actuator. The applied force is between 10 MPa and 40 MPa. The rotation-type actuator of the example was manufactured by applying a force of 26 MPa, and had a rotation angle of 45° and a spring index of 1.14. The manufactured actuator was manufactured through heat treatment at 210° C. for 2 hours under vacuum. When the actuator was manufactured so that top and bottom portions of the actuator had different structures, the actuator was manufactured by fixing a central point of the actuator, coiling the top portion in a Z type and coiling the bottom portion in an S type (or versa).

However, a total of 4 types of rotation-type actuators were manufactured by twisting and coiling the nylon 6,6 fiber so that the rotation-type actuators had different structures.

When both of the top and bottom portions are coiled in a chiral Z type, there were a ZZ-N structure formed by coiling a fiber before a coil is formed, and a ZZ-C structure formed in a coil structure. Also, in a ZS structure in which the top and bottom portions had different chiral Z and S types, there were a ZS-N structure formed by coiling a fiber before a coil is formed and a ZS-C structure formed in a coil structure.

The different representative types of the rotation-type actuators are shown in detail in FIG. 1.

More specifically, an actuator (ZZ-C) of Example 1 which had two fixed end portions and was in a shape in which both of top and bottom portions were coiled in a chiral Z type after being twisted, an actuator (ZZ-N) of Example 2 which had only one fixed end portion and had only a twisted structure without undergoing a process of coiling an actuator in a chiral Z type or chiral S type, an actuator (ZZ-C) of Example 3 which had only one fixed end portion and was in a shape in which both of top and bottom portions were coiled in a chiral Z type after being twisted, and an actuator (ZS-C) of Example 4 which had two fixed end portions and was in a shape in which a top portion was coiled in a chiral Z type and a bottom portion was coiled in a chiral S type after being twisted were manufactured.

The twist number (turns) applied when the twisted or coiled structure was formed was calculated by dividing a final length of a muscle, and denoted as turns/m. Here, the twist number was calculated from the following [Equation 3]. The bias angle was checked and recorded from a surface of a twisted nylon 6,6 fiber.

turns/m=tan⁻¹(2πrT) [Equation 3]

In [Equation 3], r represents a radial distance from the center of a fiber, and T represents a degree of twisting of the fiber with respect to an initial length of the fiber.

### PREPARATIVE EXAMPLE 5

### Energy Harvesting Device

An energy harvesting device capable of converting heat energy into electrical energy using the rotation-type actuator of the present invention was designed. A structure of the energy harvesting device is shown in detail in FIG. 2A to FIG. 2C.

Both end portions of a rotation-type actuator manufactured in Preparative Example 1 were fixed, and a magnetic material was located in the center of the rotation-type actuator. The energy harvesting device was manufactured by arranging a coil arranged to be spaced apart from the actuator so that the coil was located 1 mm from the magnetic material provided in the actuator. In this case, the coil was connected to an oscilloscope, and a coil used in an ordinary clock was used as the coil.

The actuator manufactured in Preparative Example 1 rotated clockwise or counterclockwise due to a repeated action in which a coiled structure of the actuator is uncoiled and recoiled as a temperature of ambient air increases or decreases. As a result, changes in voltage according to time induced by changing a magnetic flux passing through the coil through induced rotation of the magnetic material were measured using an oscilloscope connected to the coil. In the measured graph, the number of peaks of a voltage signal according to the temperature indicates the twist number (rotation angle) of the actuator, and the rotation speed (rpm) was able to be determined through calculation using frequency (Hz).

### PREPARATIVE EXAMPLE 6

### Energy Harvesting Device

Unlike the energy harvesting device of Preparative Example 5 having the coil installed on one surface thereof, an energy harvesting device was manufactured in the same manner as in Preparative Example 5, except that a coil was installed to surround a magnetic material on the whole while being spaced apart a distance of 1 mm from the magnetic material provided at the center of the actuator. A structure of the energy harvesting device is shown in detail in FIG. 4.

To check a difference between a structure having only a twist and a structure having a coiled shape in the rotation-type actuator according to the present invention, the rotation-type actuator was photographed using SEM. An image of the rotation-type actuator is shown in FIG. 5.

FIG. 5(a) shows a configuration of the rotation-type actuator having a twisted structure, which is manufactured by coiling a fiber at 10,000 turns/m. In this case, the rotation-type actuator was manufactured using nylon 6,6, and manufactured at a tensile force of 26 MPa. As a result, the rotation-type actuator had a diameter of 29 μm before coiling, and a twist angle of 45°.

FIG. 5(b) shows a structure coiled in a chiral Z type or chiral S type, which is manufactured by coiling a fiber at 56,000 turns/m. In this case, the rotation-type actuator had an external diameter of 62 μm and a spring index of 1.14.

FIG. 6 is a graph showing the temperature, voltage and rotation number according to time measured from the energy harvesting device manufactured in Preparative Example 5 to measure the rotation speed and rotation number (rotation angle) of the rotation-type actuator in response to a temperature fluctuation. The actuator (ZZ-C) manufactured in Preparative Example 1 was used in the energy harvesting device, and a thermocouple was installed to measure a temperature fluctuation of the air around the rotation-type actuator.

Referring to FIG. 6, it can be seen that the voltage and rotation number increased when there was a high fluctuation in temperature around the actuator.

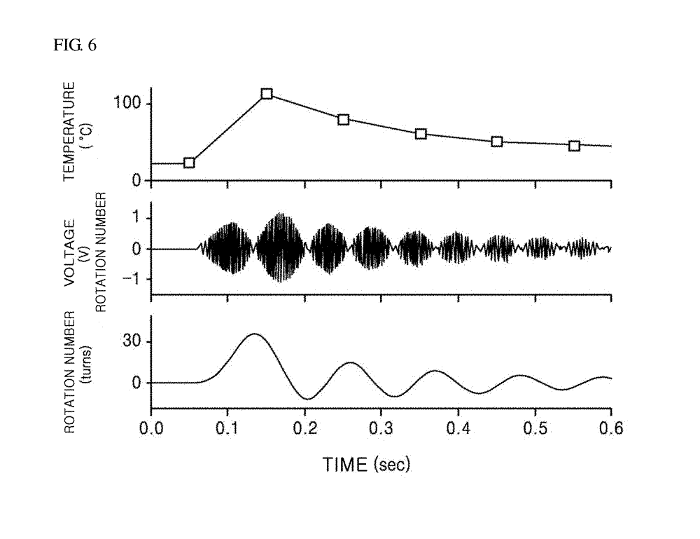

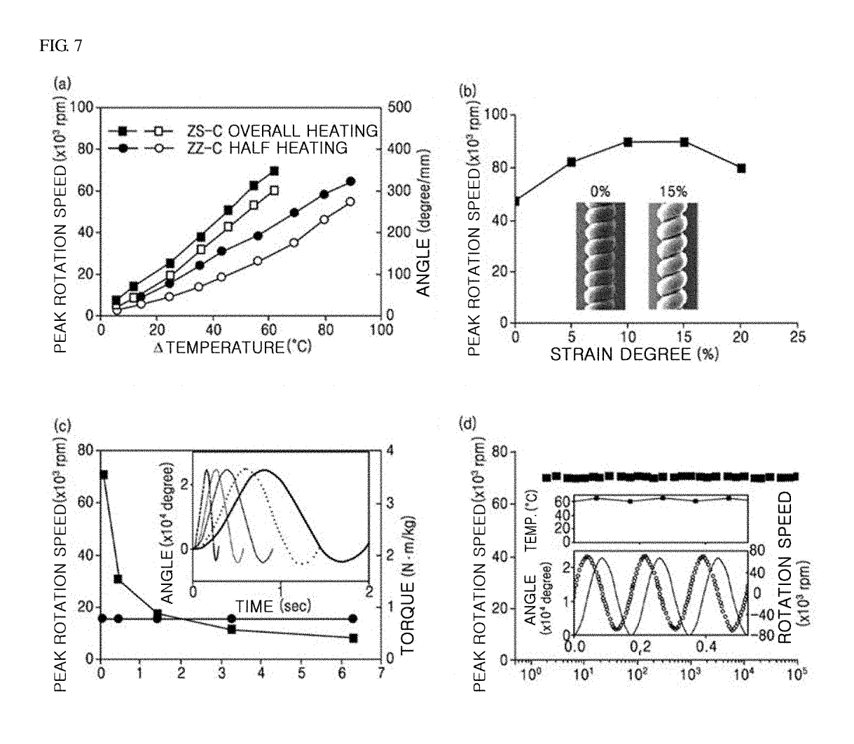

FIG. 7a is a graph showing rotation speeds of the actuators (ZZ-C and ZS-C) manufactured in Preparative Examples 1 and 4 in response to a temperature fluctuation, FIG. 7b is a graph showing rotation speeds of the actuators (ZZ-C and ZS-C) manufactured in Preparative Examples 1 and 4 in response to a tensile strain, FIG. 7c is a graph showing rotation speeds of the actuators (ZZ-C and ZS-C) manufactured in Preparative Examples 1 and 4 in response to a moment of inertia of the magnetic material, and FIG. 7d is a graph showing a rotation speed of the actuator (ZS-C) manufactured in Preparative Example 4 in response to the number of heating/cooling cycles. In this case, the actuator (ZS-C) manufactured in Preparative Example 4 and having a diameter of 27 μm and an entire length of 95 mm was used. In FIG. 7a, a graph plotted for the rotation angle according to temperature is denoted by hollow figures, and a graph plotted for the rotation speed according to temperature is denoted by filled figures.

Referring to FIG. 7, the actuator (ZS-C) manufactured in Preparative Example 4 was able to be actuated when the actuator was heated on the whole since the bottom and top portions are formed in a reverse structure so that the bottom and top portions do not interfere with each other when coiled and uncoiled. Such an actuator (ZS-C) had a rotation speed, rotation number and energy twofold higher than the ZZ-C whose half was heated to be actuated (FIG. 7a).

Considering that the heated portion is all or some of the actuator, it was judged that the ZZ-C and ZS-C actuators eventually had similar rotation speeds with respect to the weight or length of the heated actuator.

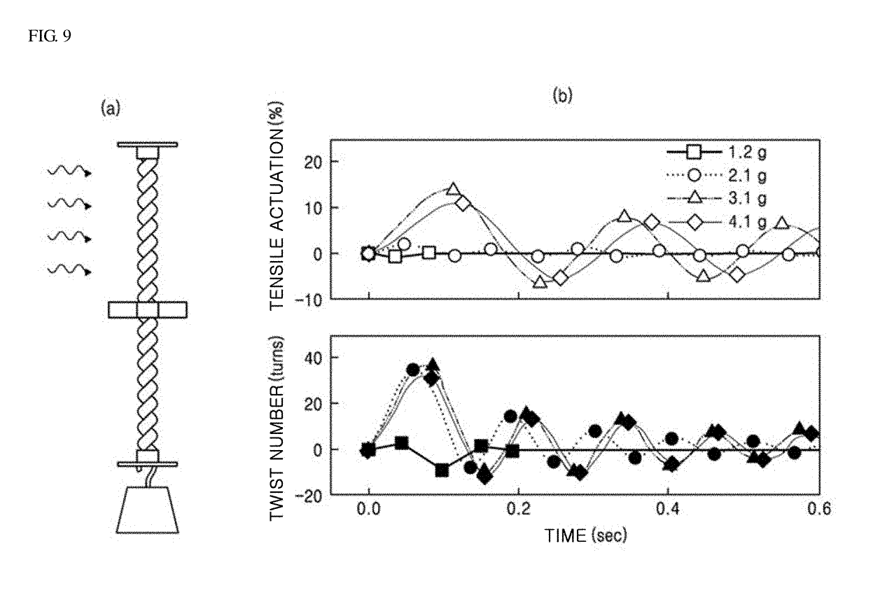

The actuators (ZZ-C and ZS-C) having two fixed end portions were structurally modified due to thermal expansion. In this case, the stretched coil structure was contracted by heat. The actuator was manufactured using a position variation support, or manufactured by fixing both end portions and stretching the end portions so that the actuator was easily structurally modified by heat, and a rotation speed was measured according to a stretching degree (FIG. 7b). As a result, it was revealed that the 8 cm-long ZS-C actuator had a maximum rotation speed of 70,200 rpm when the ZS-C actuator was stretched by 10 to 15%. The unstretched actuator had a narrow surface area to absorb heat, compared to the actuator stretched by 15%, and a low rotation speed, compared to the actuator stretched by 15%, since friction between coils occurred due to the thermal expansion. The results of FIG. 9 show that the unstretched actuator does not contract but expands by heat and that the unstretched actuator has a lower rotation speed, which supports this fact.

The rotation speed and rotational torque by the moment of inertia according to the weight of the magnetic material located in the center of the actuator (ZS-C) manufactured in Preparative Example 4 were measured (FIG. 7c). As a result, it was confirmed that the rotational torque was constant but the speed gradually dropped according to the weight of the magnetic material. That is, it can be seen that the rotation speed of the actuator can be controlled by adjusting the weight of the magnetic material of the actuator.

The actuator (ZS-C) manufactured in Preparative Example 4 had a weight of 238 μg, and thus a rotational torque of the actuator (ZS-C) was calculated to be 187 nN·m and 0.77 mP·m/kg according to the following [Equation 4].

τ=I·a [Equation 4]

In [Equation 4], a represents the initial acceleration of the magnetic material, and I represents a moment of inertia of the magnetic material, which was calculated according to the following [Equation 5].

I=1/4MR²+1/12ML² [Equation 5]

In [Equation 5], M represents a mass of the magnetic material, R represents a radius of the magnetic material, and L represents a length of the magnetic material.

In this case, the rotation angle was maintained regardless of the weight of the magnetic material, indicating that the weight of the magnetic material has no influence on the conversion of heat energy into rotating force using the rotation-type actuator, and the weight of such a magnetic material was able to adjust one cycle time (that is, an interval) in which a coiled structure was uncoiled and recoiled by heating and cooling.

The results of FIG. 7d showed that the rotation speed and rotation angle of the actuator of the present invention hardly decreased when the number of heating/cooling cycles was similar to a torsional actuation period.

That is, from the results of FIGS. 7c and 7d, it was confirmed that, when a magnetic material having a weight 24 times heavier than the actuator was provided for persistent stability of the actuator (ZS-C) manufactured in Preparative Example 4, the actuator had a stable and continuous rotation speed during 300,000 cycles.

FIG. 8 is a graph showing results of comparison of rotation speeds according to the temperature of the actuators (ZS-C, ZS-N, ZZ-C and ZZ-N) having various structures according to the present invention. In this case, the actuator (ZS-C) manufactured in Preparative Example 4, the actuator (ZS-N) having two fixed end portion and only a structure twisted in a chiral Z type or a chiral S type, the actuator (ZZ-C) manufactured in Preparative Example 1, and the actuator (ZZ-N) manufactured in Preparative Example 2 were used. Also, the actuators were manufactured with a varying stretching degree (%) and a varying load (g) of the position variation support 151 of the actuator.

Referring to FIG. 8, it can be seen that the actuator having a coiled structure and stretched by 15% had a high rotation speed with an increasing temperature, particularly that the actuator was affected by the load of the position variation support when the actuator simply had only a twisted structure.

Also, the actuator (ZS-C) manufactured in Preparative Example 4 had superior rotation speed, rotation number, compared to the actuators having different structures. As described above, it can be seen that the actuator (ZS-C) had a rotation number and rotation speed twofold higher than the actuator manufactured in Preparative Example 1 which rotated when a half of the actuator was heated as described above.

FIG. 9 is a graph showing results obtained by measuring the rotation number and tensile actuation of the actuator (ZZ-C, Preparative Example 3) provided with a different load (1.2 g, 2.1 g, 3.1 g, or 4.1 g) of the position variation support according to time so as to check an effect of the load of the position variation support located below the actuator. In this case, the position variation support is shown in the form of a pendulum at a lower portion of the actuator in FIG. 9a, and a half of each of the actuators was heated.

Referring to FIG. 9, it was confirmed that, when the load of the position variation support was 1.2 g, a rotation speed was significantly low, compared to when other position variation supports were provided.

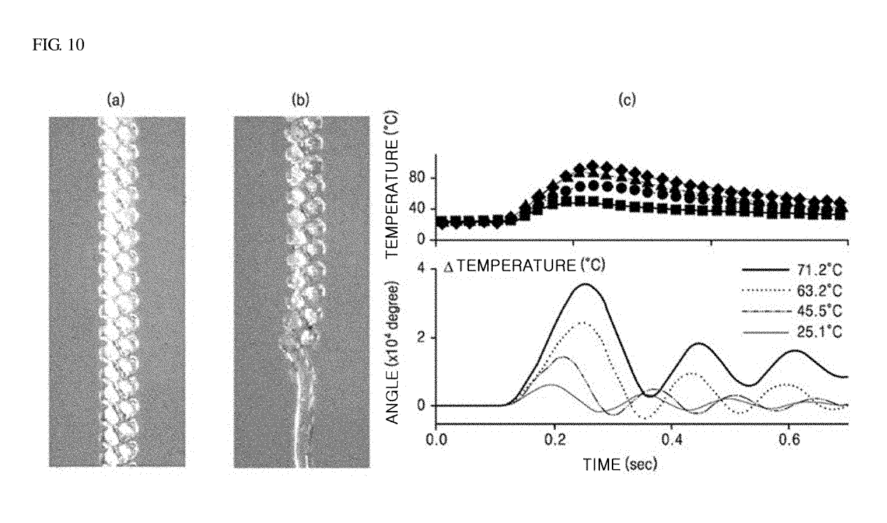

FIG. 10a is an actual image of the actuator (ZS-C) manufactured in Preparative Example 4, which is stretched by 20%, FIG. 10b is an actual image of the actuator (ZS-C) manufactured in Preparative Example 4, which is irreversibly changed in a state in which a partially coiled structure is untwisted, and FIG. 10c is a graph showing a change in rotation angle with an increasing temperature of the actuator (ZS-C) manufactured in Preparative Example 4, which is stretched by 15%.

Referring to FIG. 10, it was confirmed that the actuator had the best rotation speed when a stretching degree was in a range of 10 to 15%, and that the structure of the actuator was irreversibly changed, as shown in FIG. 7b, when the temperature rose to 90° C. or more in the case of the actuator stretched by 15%.

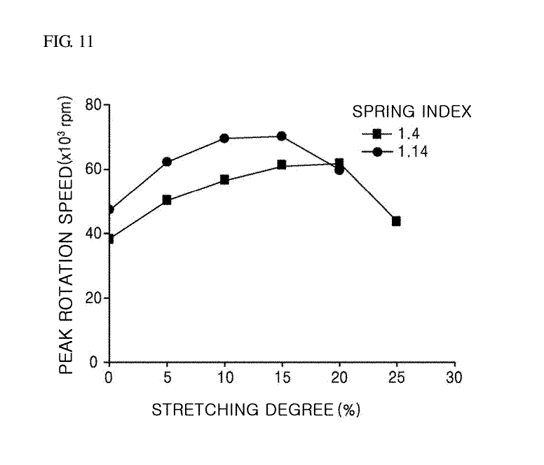

FIG. 11 is a graph showing results of measuring and comparing a rotation speed according to the stretching degree of the actuator (ZS-C) manufactured in Preparative Example 4 so as to check an effect of a spring index on the actuator of the present invention. Referring to FIG. 11, it can be seen that the actuator (ZS-C) having a spring index of 1.14 had a high rotation speed, compared to the actuator (ZS-C) having a spring index of 1.4.

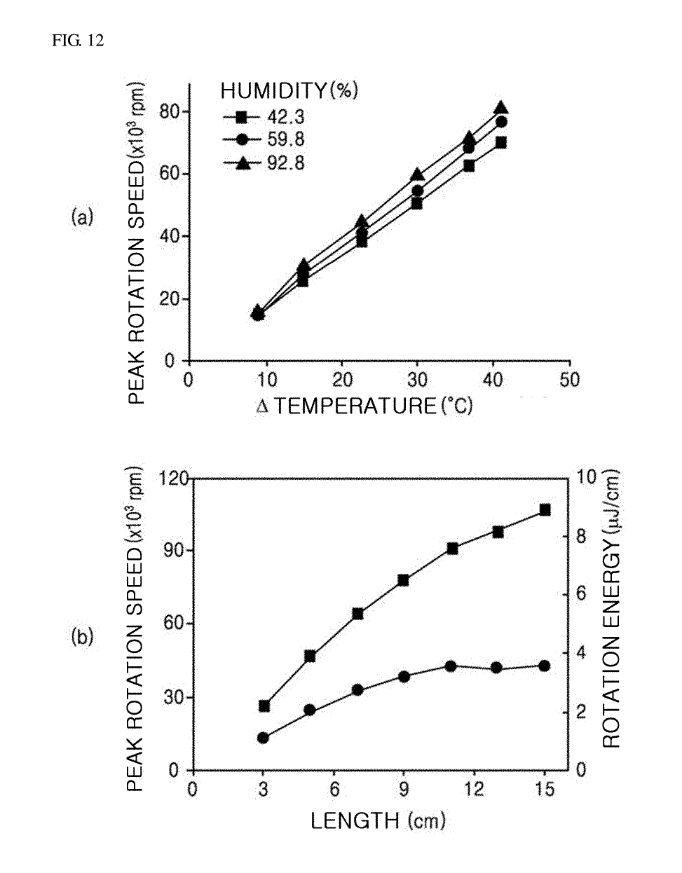

FIG. 12a is a graph showing results of measuring a rotation speed of the actuator (ZS-C) manufactured in Preparative Example 4 according to humidity. Referring to FIG. 12a, it can be seen that the actuator had a rotation speed of 80,640 rpm at a high humidity (92.8%), the value of which further increased by 12.87%, compared to that at a low humidity (42.3).

FIG. 12b is a graph showing results of measuring a rotation speed according to the entire length of the actuator (ZS-C) manufactured in Preparative Example 4 under a condition of 42.3% humidity. Referring to FIG. 12b, it can be seen that the rotation speed of the actuator (ZS-C) manufactured in Preparative Example 4 is proportional to length. It can be seen that the rotation speed of the actuator (ZS-C) manufactured in Preparative Example 4 is also proportional to length, and was observed to be up to 140,000 rpm at a length of 15 cm.

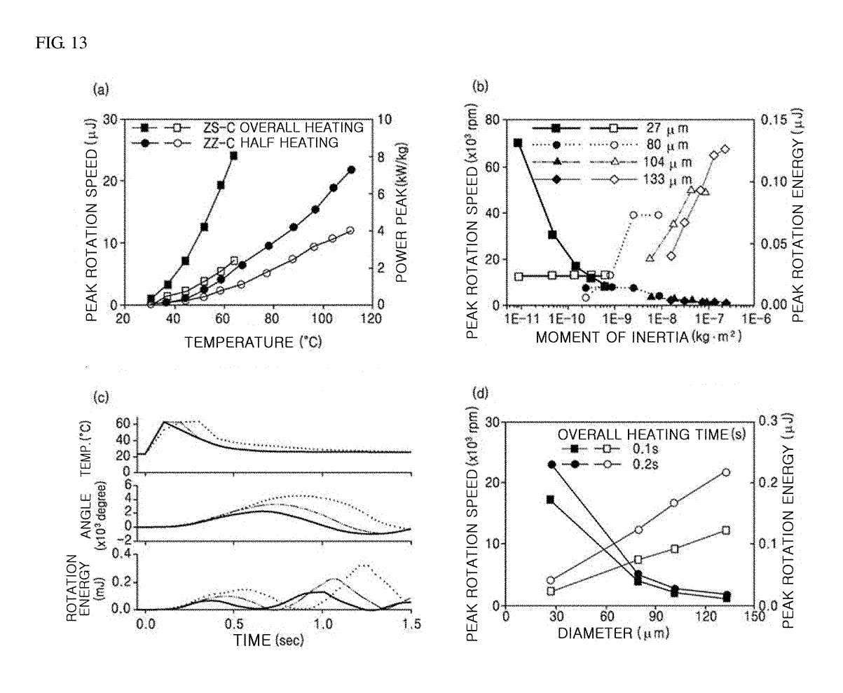

FIG. 13a is a graph of comparing rotation energy of the actuators (ZZ-C and ZS-C) manufactured in Preparative Examples 1 and 4 according to temperature, FIG. 13b is a graph showing the relationship between the rotation speed (closed figures) and rotation energy (open figures) of the actuator (ZS-C, Preparative Example 4) having different diameters according to a moment of inertia, FIG. 13c is a graph showing the temperature fluctuation, rotation angle and rotation energy of the actuator (ZS-C) manufactured in Preparative Example 4 according to time, and FIG. 13d is a graph showing the relationship between the rotation energy and the rotation speed according to the diameter of the actuator (ZS-C) manufactured in Preparative Example 4. In this case, the weight of the actuator was set to 238 μg.

Referring to FIG. 13, it can be seen that the actuator (ZZ-C) manufactured in Preparative Example 1 whose half was heated generated an energy of 11,900 W/kg, the value of which was 40 times higher than conventional electric motors, and 198 times higher than CNT fibers (71.9 W/kg).

It was observed that, when a fluctuation in temperature by the air heated for 0.1 seconds was 64° C., the rotating force of the actuator (ZS-C) manufactured in Preparative Example 4 according to diameter was proportional to the moment of inertia, and the rotation speed rose according to the heating time at a constant temperature.

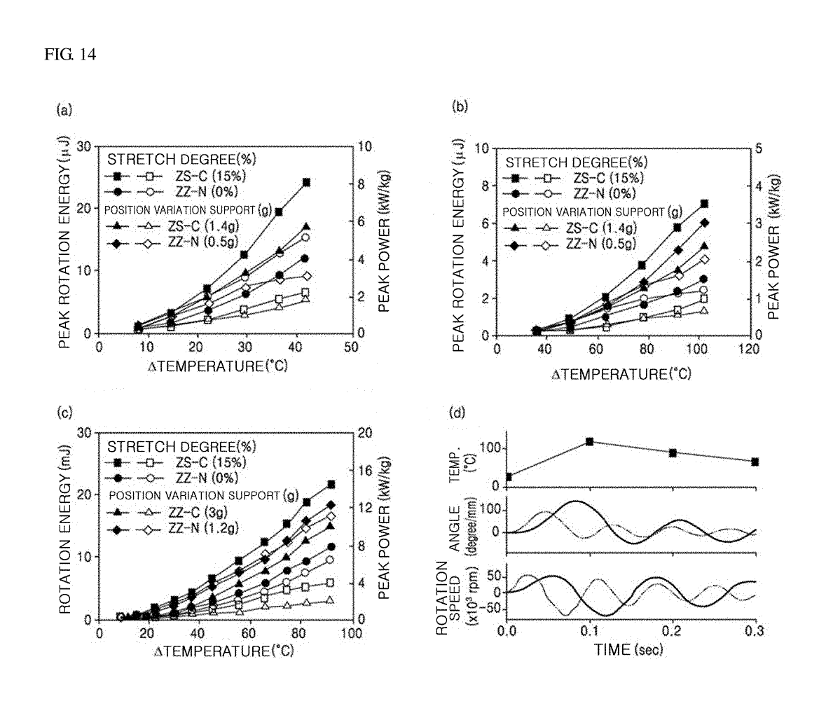

FIG. 14a is a graph of comparing the relationship between rotation energy and force measured after the actuator (ZS-C (Preparative Example 4)) and a type of the actuator (ZS-N) having only a twisted structure are heated on the whole, FIG. 14b is a graph of comparing the relationship between rotation energy and force measured after halves of the actuator (ZS-C (Preparative Example 4)) and a type of the actuator (ZS-N) having only a twisted structure are heated, FIG. 14c is a graph of comparing the relationship between rotation energy and force measured after halves of the actuator (ZZ-C (Preparative Example 1)) and a type of the actuator (ZZ-N) having only a twisted structure are heated, and FIG. 14d is a graph of comparing temperature fluctuations, rotation angles and a rotation speeds of the actuator (ZZ-C (Preparative Example 1)) and a type of the actuator (ZZ-N) having only a twisted structure according to time. In this case, the actuator (ZZ-C) manufactured in Preparative Example 1 which had a diameter of 27 μm and was stretched by 15% was used in FIG. 14d, and was indicated by black lines on the graph, and a type of the actuator (ZZ-N) having only a twisted structure having a diameter of 27 μm and including the position variation support of 1.2 g was used, and indicated by red lines on the graph.

Referring to FIG. 14, it can be seen that the actuator having a coiled structure whose both end portions were fixed had higher rotation energy than the other types of the actuators. However, it was confirmed that the actuator which did not have a coiled structure whose both end portions were fixed but had only a twisted structure had low rotation energy, compared to the other types of the actuators, but had high rotation energy, considering the weights.

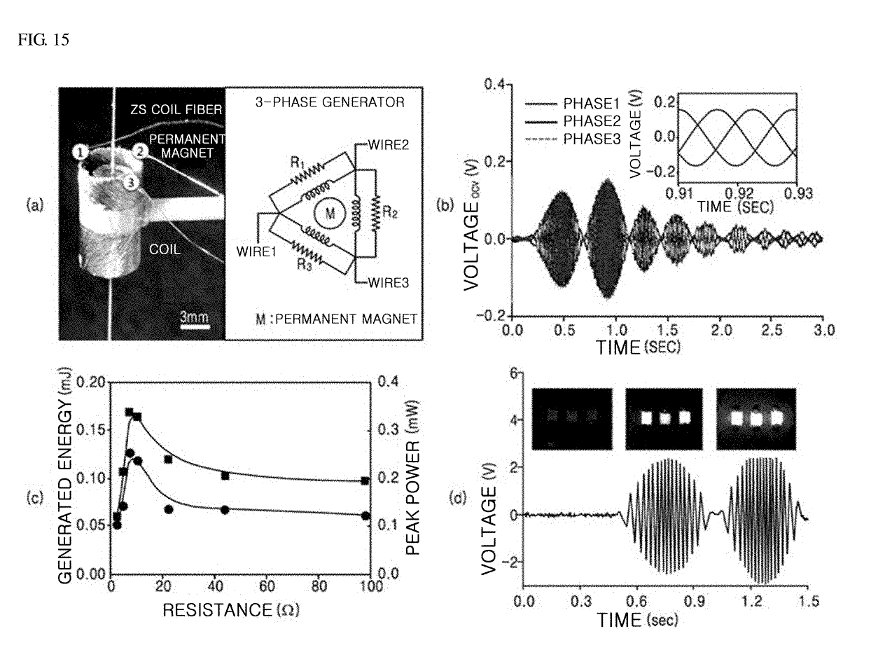

FIG. 15 is a diagram that demonstrates the energy harvesting device manufactured in Preparative Example 6. Here, the device includes the actuator having a 102 μm-long ZS-C structure (Preparative Example 4), and was manufactured using the three coils and a cylindrical neodymium magnetic material.

Since the actuator (ZZ-N) manufactured in Preparative Example 1 had mechanical force and energy density higher than the ZS-C, but had a rotation speed and a rotation number lower than the ZS-C, the ZS-C was used in this device. Also, the proper diameter of the actuator and the proper weight of the magnetic material, which had been obtained from experiments, were applied to the device so that the device had a high energy conversion rate.

FIG. 15b is a graph showing results of measuring a change in voltage according to the time corresponding to the three coils of the device of FIG. 15a. Referring to FIG. 15b, it was confirmed that the rotation speed of the ZS-C actuator in the device was 3,120 rpm, and energy up to 0.16 V_{ocv} was generated.

Also, the following [Equation 6] was used to calculate the energy conversion efficiency from the device.

$$Efficiency ( η ) = \frac{3 {\int }_{{t}_{1}}^{{t}_{2}} \frac{{V}^{2}}{R} dt}{{\sum }_{n = 1}^{n} \frac{1}{2} I \cdot ω {n}^{2}} \qquad [ Equation 6 ]$$

In [Equation 6], V represents a generated voltage, t₁ represents an initial time, and t₂ represents a time at which the magnetic material is stopped.

I represents a moment of inertia, and ω represents a rotation angular velocity in each of twisting and untwisting.

A ZS-C muscle used in the device generated an energy of 0.056 kJ/kg, and generated an energy of 62 μJ/cm³ at a temperature fluctuation of 65° C. It was confirmed that three LEDs were operated using the electrical energy obtained from the torsional energy of the device (FIG. 15d), indicating that the device using the rotation-type actuator had superior performance to the devices using a graphene fiber.

Referring to FIG. 15d, it was confirmed that, when the actuator (ZS-C) manufactured in Preparative Example 4 was heated for a long time of 0.3 seconds, the coiled structure was untwisted, but retwisted when a higher rotating force is applied to the coiled structure because the modulus of elasticity was lowered due to latent heat remaining in the actuator.

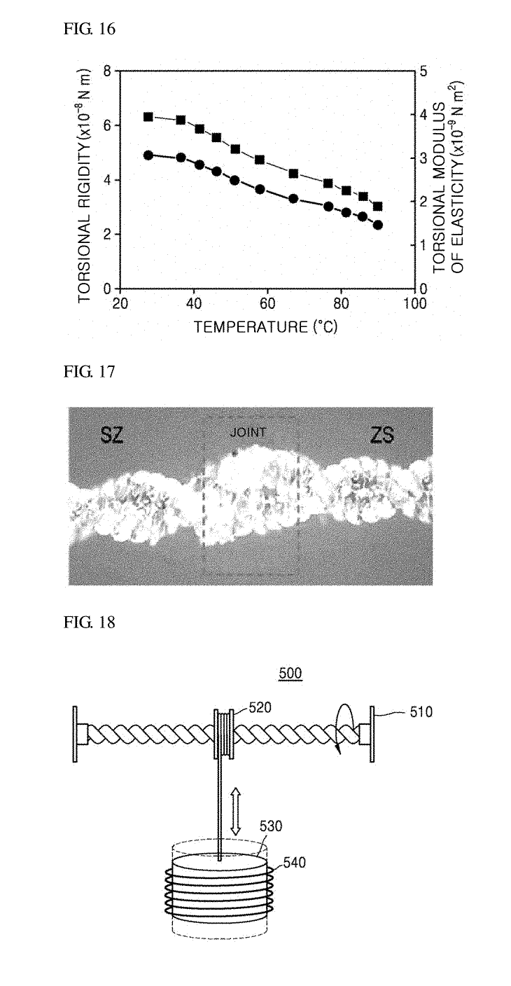

FIG. 16 is a graph showing the torsional rigidity and torsional modulus of elasticity of the ZS-C rotation-type actuator having a diameter of 27 μm according to temperature. It can be observed that the rotation-type actuator more rapidly returned to an original state when the temperature around the rotation-type actuator dropped, compared to when the temperature around the rotation-type actuator rose. Referring to FIG. 16, it can be seen that the torsional modulus of elasticity decreased when the temperature of the actuator rose. From the result, it can be seen that, when the actuator was recoiled as the ambient temperature dropped, the torsional modulus of elasticity was lowered due to latent heat remaining in the actuator, and thus the actuator more rapidly returned to an original state.

### PREPARATIVE EXAMPLE 7

### Energy Harvesting Device

Unlike the energy harvesting device of Preparative Example 5 having the coil installed on one surface thereof, an energy harvesting device was manufactured in the same manner as in Preparative Example 5, except that coils were installed at both sides of the energy harvesting device. Here, the rotation-type actuator was manufactured using an actuator having a ZS-C structure having a diameter of 27 μm.

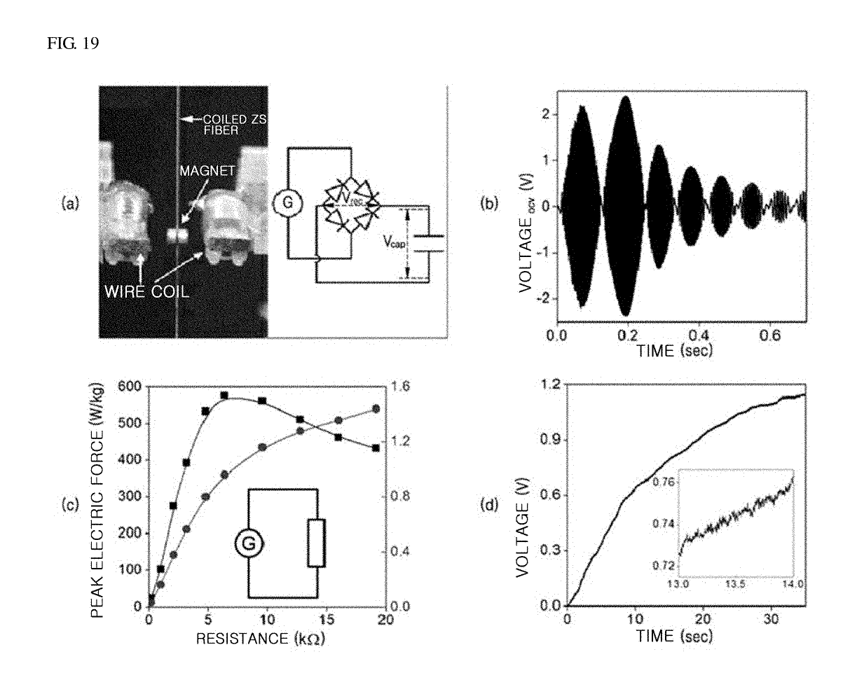

FIG. 19b is a diagram showing a voltage generated in response to a temperature fluctuation in the energy harvesting device. It was confirmed that a voltage of 2.2 V was generated when a change in temperature from room temperature to approximately 45° C. was caused.

FIG. 19c is a diagram showing results of measuring an electric force and voltage according to the resistance of the energy harvesting device. It was confirmed that the energy harvesting device generated an energy of 560 W/kg with respect to the maximum weight of the actuator through impedance matching.

FIG. 19d is a diagram showing voltage charged in a capacitor (330 μF-10V) after the voltage is generated by setting an uncoiling/coiling period of the rotation-type actuator and a temperature fluctuation period (from 67.6° C. to 87.2° C.) to 5 Hz in the energy harvesting device and then rectified using a bridge diode. It was confirmed that a voltage of 1.12 V was charged after 35 seconds, as shown in FIG. 19d.

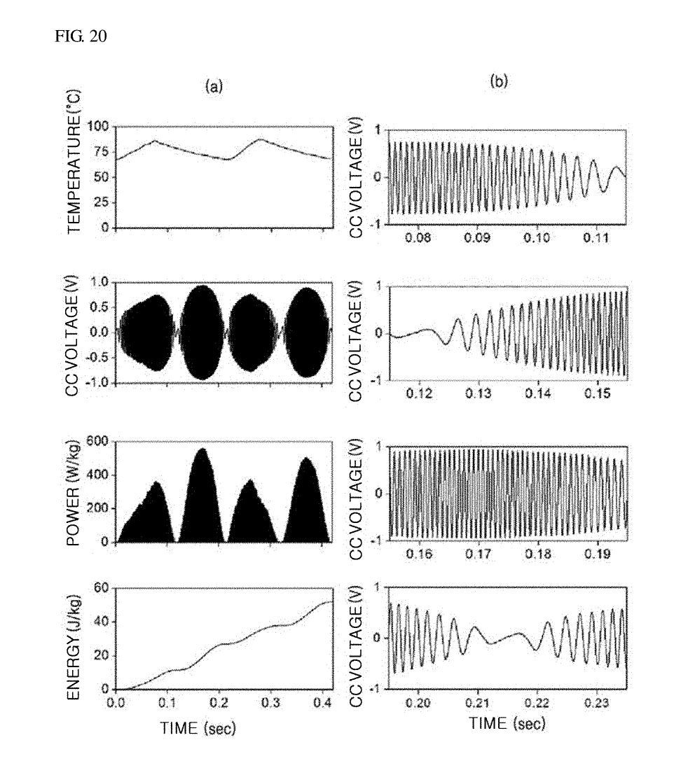

FIG. 20 is a graph showing results of measuring energy generated when an uncoiling/coiling period and a temperature fluctuation (19° C., from 67.6° C. to 87.2° C.) period of the rotation-type actuator were set to the same frequency of 5 Hz in the energy harvesting device. It was confirmed that an average power of 124 W/kg was able to be obtained with respect to the weight of the actuator, as shown in FIG. 20.

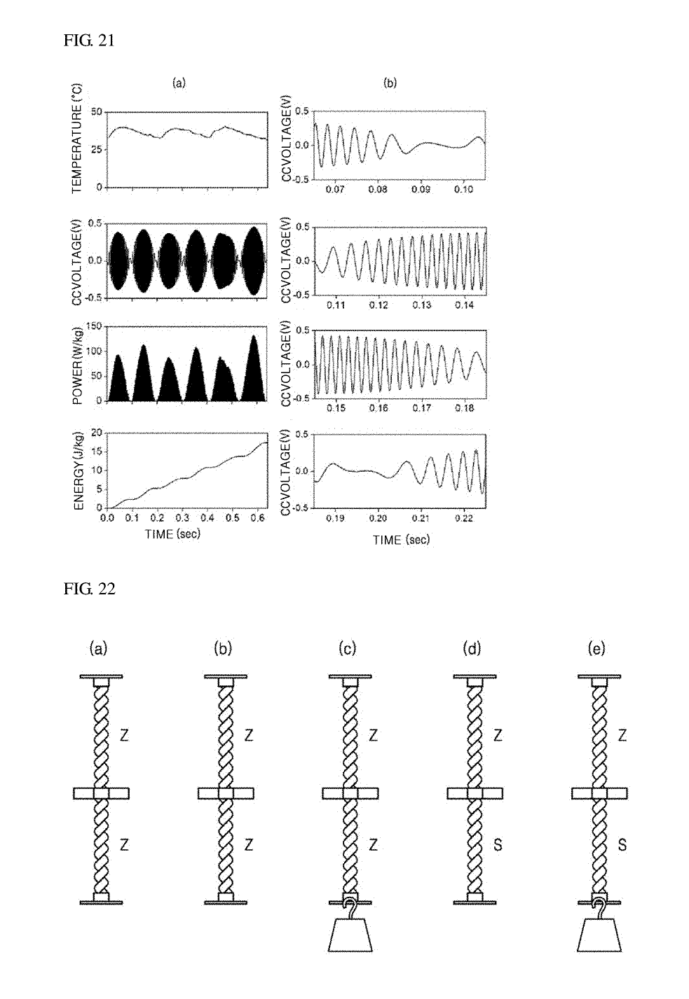

FIG. 21 is a graph showing results of measuring energy generated when an uncoiling/coiling period and a temperature fluctuation (8.2° C., from 32.5° C. to 40.7° C.) period of the rotation-type actuator were set to the same frequency of 5 Hz in the energy harvesting device. It was confirmed that the rotation-type actuator was actuated at the maximum rate of 33,000 rpm under the conditions, and an instantaneous power of 132 W/kg and an average power of 26.8 W/kg were generated, as shown in FIG. 21.

### PREPARATIVE EXAMPLE 8

### Manufacture of Polyurethane Rotation-Type Actuator

1) Preparation of Polyurethane Spinning Solution

Polyurethane (SMP MM-2520, SMP Technologies Inc. from Japan) was dissolved in tetrahydrofuran (Aldrich) at room temperature for 7 days to prepare a polyurethane spinning solution. In this case, the spinning solution was prepared by dissolving 5.5% by weight of the polyurethane, based on the total weight ratio of the spinning solution.

2) Electrospinning: Manufacture of Polyurethane Sheet

The polyurethane spinning solution prepared in step 1) was subjected to an electrospinning method to manufacture a polyurethane sheet having a unidirectional orientation property. In this case, the electrospinning conditions were as follows: the polyurethane spinning solution was supplied at a rate of 13 μL/min using a syringe pump (KD Scientific USA), an applied voltage of 18 kV was applied, and thus a spinning nozzle had a voltage of +11 kV and the collector had a voltage of −7 kV. A distance between the spinning nozzle and the collector was 20 cm. Here, the voltage was applied using high-voltage DC power supply equipment (Wookyung Tech, Korea). In this case, polyurethane fibers constituting the polyurethane sheet had a diameter of approximately ˜4.5 μm.

3) Manufacture of Rotation-Type Actuator

The polyurethane sheet manufactured through the electrospinning process of step 2) was attached to a shaft of an electric motor having a flat rectangular pad and a fixed support. Coiling was applied to two fixed end portions of the polyurethane sheet under a temperature condition of 40° C. until the polyurethane sheet was in a coiled shape on the whole, thereby manufacturing a rotation-type actuator. More specifically, the rotation-type actuator was a rotation-type actuator in a coiled shape manufactured by applying coiling to the polyurethane sheet at a torsional speed of 25,000 turns/m in the same direction.

In this case, the rotation-type actuator was divided into top and bottom portions with respect to the inner part thereof, and various types of the rotation-type actuators were able to be manufactured according to the coiling directions of the top and bottom portions.

First, the rotation-type actuator was able to be manufactured by coiling the top and bottom portions of the rotation-type actuator in the same direction (a Z type or an S type), or manufactured by coiling the top and bottom portions in different directions (a chiral structure in which, when one end portion is in a Z type, the other end portion is in an S type).

Also, the rotation-type actuator may be in a twisted shape formed by twisting the rotation-type actuator before a coil is formed, or may be in a coiled shape formed by further applying coiling to the twisted shape.

### PREPARATIVE EXAMPLES 9 TO 12

Rotation-type actuators were all manufactured in the same manner as in Preparative Example 8, except that coiling was applied to the polyurethane sheet manufactured through the electrospinning in Preparative Example 8 at a torsional speed of 19,000 turns/m (Preparative Example 9), 21,000 turns/m (Preparative Example 10), 23,000 turns/m (Preparative Example 11), and 27,000 turns/m (Preparative Example 12) to manufacture the rotation-type actuators in a partially coiled twisted shape or a coiled shape.

### PREPARATIVE EXAMPLE 13

### Energy Harvesting Device

An energy harvesting device capable of converting heat energy into electrical energy was designed using the rotation-type actuator manufactured in Preparative Example 8. A structure of the energy harvesting device is shown in detail in FIG. 2.

Two end portions of the rotation-type actuator manufactured in Preparative Example 8 were fixed, and a magnetic material was located in the center of the rotation-type actuator. The energy harvesting device was manufactured by arranging a coil to be spaced apart from the rotation-type actuator so that the coil was located 1 mm from the magnetic material provided in the actuator. In this case, the coil was connected to an oscilloscope, and a coil used in an ordinary clock was used as the coil.

In the rotation-type actuator manufactured in Preparative Example 8, a temperature gradient in the rotation-type actuator occurred in response to a difference in temperature of the ambient air, then the rotation-type actuator rotated clockwise or counterclockwise due to a repeated action in which a coiled structure of the rotation-type actuator was uncoiled and recoiled, thereby inducing rotation of the magnetic material. The rotation of the magnetic material induced changing a magnetic flux passing through the coil thereby inducing a change in voltage, and the change in voltage according to time was measured using an oscilloscope connected to the coil.

Measurement of Rotation Speed and Rotation Number

To measure a rotation speed of the rotation-type actuator, two methods were used. One method was performed using a super high-speed camera (1000 frames per second, Phantoms), and the other method was performed by measuring a change in direction of the magnetic field.

The method of measuring a change in direction of the magnetic field will be described in detail. A magnetic material to the center between top and bottom portions of the rotation-type actuator manufactured in Preparative Example 8 was attached so that a change in magnetic field was able to be caused when the rotation-type actuator was actuated in response to a temperature gradient. In this way, a voltage was generated from the coil installed around the rotation-type actuator, and the voltage was then recorded by an oscilloscope.

That is, voltage signals associated with the rotation speed and rotation number of the rotation-type actuator were able to be determined as the number of vibrations (Hz) and the number of peaks in response to time. Peak rotation speed per minute were calculated as the maximum number of vibrations (Hz)×60. The same results were observed in the two methods.

Analysis of Physical Properties of Rotation-Type Actuator

1) Morphological Analysis

The shape of the rotation-type actuator was analyzed using a scanning electron microscope (FE SEM, Hitachi S4700).

2) Dynamic Mechanical Analysis

To analyze the thermal characteristics of the rotation-type actuator, a dynamic mechanical analyzer (Seiko Exstar 6000) was used. In this case, the temperature was measured using a thermocouple.

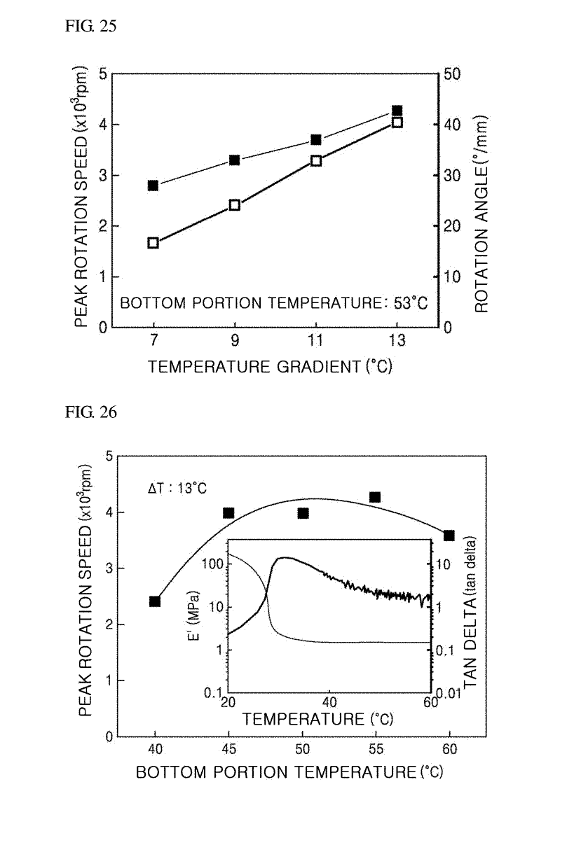

FIG. 25 is a graph showing results of measuring a rotation speed (▪) and a rotation angle (□) of the rotation-type actuator (having a length of 12 cm and a diameter of 100 μm) manufactured at Preparative Example 8 which had a bottom portion whose temperature was held constant at 53° C. and thus had a temperature gradient.

As shown in FIG. 25, it was confirmed that the rotation speed and the rotation angle increased in response to the difference in temperature (7 to 13° C.) between the top and bottom portions due to the temperature gradient in the rotation-type actuator of Preparative Example 8. In this way, it can be seen that the rotation-type actuator according to the present invention provided a rotation speed since the difference in temperature between the top and bottom portions was greater than or equal to 1° C., and that a sufficient rotation speed of approximately 1,000 rpm was provided at a temperature of 3° C. or higher. Therefore, it can be seen that the rotation-type actuator according to the present invention was able to provide rotation energy, that is, a rotation speed when the difference in temperature was greater than or equal to 1° C., preferably able to provide a high rotation speed and rotation angle at 3 to 30° C., more preferably 9 to 13° C.

FIG. 26 is a graph showing results of measuring a rotation speed (▪) of the rotation-type actuator (having a length of 12 cm and a diameter of 100 μm) manufactured in Preparative Example 8 when the temperature of the bottom portion was in a range of 40 to 60° C. in a state in which the difference in temperature between the top and bottom portions of the rotation-type actuator was held constant at 13° C.

As shown in FIG. 26, it was confirmed that, since the rotation-type actuator of Preparative Example 8 was a rotation-type actuator using polyurethane and a glass transition temperature (Tg) of the polyurethane was 30.6° C., the rotation-type actuator of Preparative Example 8 was able to provide a sufficient rotation speed when the difference in temperature between the top and bottom portions was held constant at 13° C. and when the rotation-type actuator was greater than or equal to 30° C. which is the glass transition temperature (T_{g}). However, the best rotation stroke was able to be provided when the temperature of the bottom portion was in a range of 45 to 60° C.

In this way, the rotation-type actuator according to the present invention was able to provide a sufficient rotation speed at a temperature of 30° C. or higher, preferably 40° C. or higher, and further preferably at a temperature of 43° C. or higher to have a rotation speed of 3,000 rpm or more. However, since the rotation speed gradually dropped at a temperature of 60° C. or higher, a temperature of up to approximately 80° C. at which the rotation-type actuator provided a sufficient rotation speed was preferred, and a temperature of 60° C. or less was further preferred.

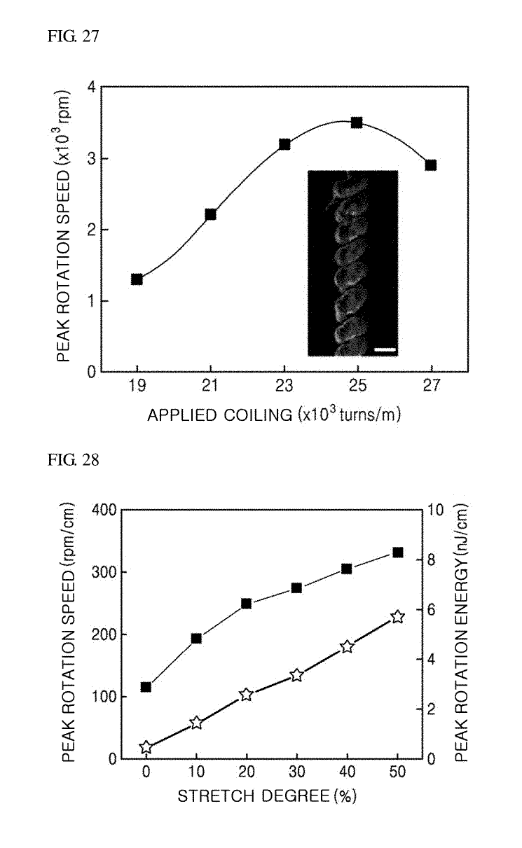

The rotation-type actuators according to the present invention had different shapes such as a twisted shape, a partially coiled twisted shape, and a coiled shape, depending on the applied twists (rotations). In this case, the performances of the rotation-type actuators having different shapes were compared. Specifically, FIG. 27 is a graph showing results of measuring a rotation speed when a difference in temperature between the top and bottom portions of the rotation-type actuators having different shapes manufactured in Preparative Examples 8 to 12 was 10° C. and the temperature of the bottom portions was 52° C. Here, all the rotation-type actuators were manufactured to have a diameter of 100 μm and a length of 8 cm.

As shown in FIG. 27, it can be seen that the rotation-type actuator manufactured in Preparative Example 8, which was coiled on the whole, had the best rotation speed. However, the rotation-type actuators manufactured in Preparative Examples 9 to 12 also had a sufficient rotation speed of 1,000 rpm or more.

That is, it can be seen that the rotation-type actuator having a sufficiently good rotation speed was able to be manufactured when the number of twists (rotations) applied during a manufacturing process was in a range of 19,000 to 35,000 turns/m, and preferably in a range of 21,000 to 30,000 turns/m so as to manufacture a rotation-type actuator having a rotation speed of 2,000 rpm or more.

FIG. 28 is a graph showing results of measuring rotation speeds and rotation energy for the rotation-type actuator manufactured in Preparative Example 8 which was tensile strained 0 to 50% with respect to the entire length before being fixed.

As shown in FIG. 28, it can be seen that the rotation-type actuator of Preparative Example 8 had a remarkably improved rotation speed per length and a remarkably improved rotation energy per length as the tensile strain (%) with respect to the entire length before being fixed increased.

In particular, it can be seen that the rotation speed was 100 rpm/cm, but the rotation energy was very low when the tensile strain was 0%. Specifically, it can be seen that the rotation speed and the rotation energy per length of the rotation-type actuator which was tensile strained 50% and fixed were 3 times and 13 times higher than the rotation speed and the rotation energy per length of the rotation-type actuator which was tensile strained 0% and fixed, respectively. Therefore, the rotation-type actuator according to the present invention was preferably tensile strained 10 to 50% with respect to the entire length before being fixed.

In this way, when the rotation-type actuator was tensile strained and fixed, clearances are provided between coils, and a large quantity of heat was increasingly absorbed through the clearances. Also, as a tensile strength increased in an untwisting direction, friction between the coils caused by the thermal expansion was reduced.

For the aforementioned reasons, the rotation-type actuator according to the present invention was able to respond rapidly to a low temperature, have a rapid rotational actuation, and provide a high rotation angle.

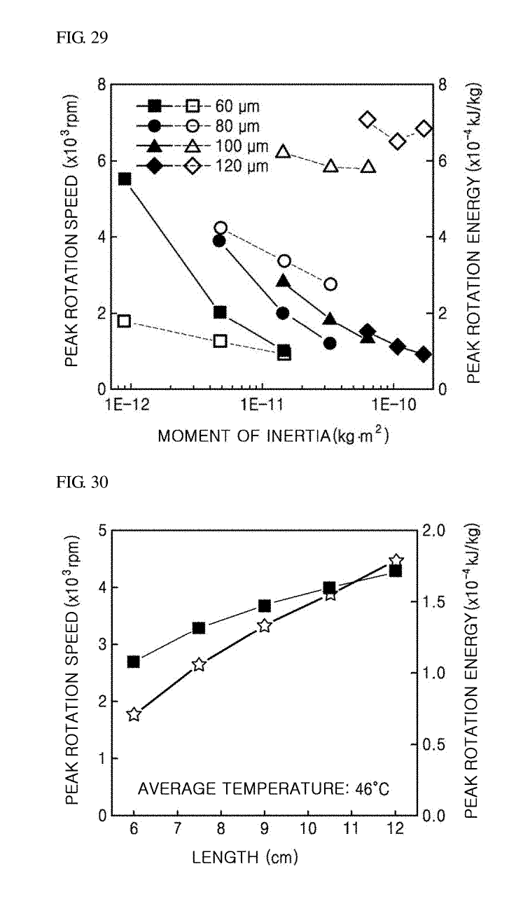

FIG. 29 is a graph showing results of measuring a rotation speed and rotation energy (torsional energy) according to the moment of inertia after a paddle is attached to the center of the rotation-type actuator having different diameters manufactured in Preparative Example 8. In this case, the rotation energy was calculated according to the following [Equation 7].

1/2(Iω²) [Equation 7]

In [Equation 7], I represents a moment of inertia, and ω represents an angular velocity.

As shown in FIG. 29, the rotation-type actuator having an optimized moment of inertia had a high rotation speed of 3,000 rpm.

Also, it was confirmed that the diameter and rotation energy of the rotation-type actuator were increased in proportion to each other because the surface area of the rotation-type actuator increased as the diameter of the rotation-type actuator increased. However, it can be seen that the rotation speed of the rotation-type actuator gradually decreased as the diameter of the rotation-type actuator increased.

Specifically, it can be seen that the rotation-type actuator had a sufficient rotation speed of 1,000 rpm when the diameter of the rotation-type actuator was in a range of 60 to 120 μm to optimize the moment of inertia of the rotation-type actuator.

FIG. 30 is a graph showing a rotation speed and rotation energy of the rotation-type actuator manufactured in Preparative Example 8 according to the length of the rotation-type actuator. In this case, the rotation-type actuator of Preparative Example 8 had a diameter of 100 μm, an average temperature of 46° C. and a temperature difference of 1.08° C./cm.

As shown in FIG. 30, it was confirmed that the rotation energy and rotation speed increased as the length of the rotation-type actuator of Preparative Example 8 increased. This was because the rotation energy of the rotation-type actuator was the square of the angular velocity.

In this way, it was confirmed that the rotation-type actuator of the present invention having a diameter of 100 μm and a length of 12 cm had a very high rotation speed of 4,285 rpm and a rotation energy density per length of 7.47 nJ/cm when the rotation-type actuator had an optimized moment of inertia, and that the rotation-type actuator was not particularly limited as long as the rotation-type actuator had a length of 6 cm or more so as to have a sufficient rotation speed of approximately 2,000 rpm.

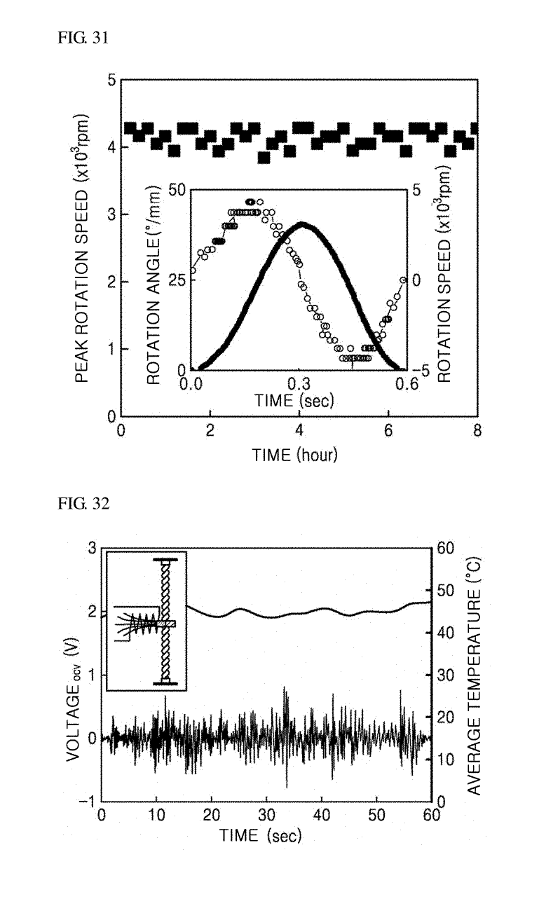

FIG. 31 is a graph showing results of measuring a rotation speed at each cycle when the rotation-type actuator manufactured in Preparative Example 8 in which the temperature of the bottom portion is 53° C. and a difference in temperature between the bottom and top portions is 13° C. was actuated for a total of 8 hours.

Here, the rotation-type actuator further had a paddle between the top and bottom portions thereof to produce a proper torque. A paddle having a weight 20 times heavier than the total weight of the rotation-type actuator was used as the paddle.

In this case, the rotation angle (▪) and the rotation speed (□) of the rotation-type actuator for one untwisting/twisting cycle due to the temperature gradient were measured, and depicted on an inset graph.

As shown in FIG. 31, it can be seen that the rotation-type actuator had reversible and constant torsional actuation without degrading the performance for 8 hours.

Also, an initial speed change (acceleration) of the paddle was 754 rad/s², the value of which was 15 times higher than that of an actuator which was composed of carbon nanotube yarn and actuated due to an electrochemical bilayer potential (Non-patent Document 4).

A torque of 1 mg of the rotation-type actuator was 11 nN·m², and calculated according to the following [Equation 8] using the initial paddle speed (acceleration; α) and the moment of inertia of the paddle (I=1/4MR²+1/12ML² where M represents a mass of the paddle, R represents a radius of the paddle, and L represents a length of the paddle).

τ=I+α [Equation 8]

FIG. 32 is graph showing a voltage (a black line) and an average temperature (a blue line) generated according to time in the energy harvesting device of Preparative Example 13 which includes a magnetic material between top and bottom portions of the rotation-type actuator manufactured in Preparative Example 8. In this case, the inset graph is a diagram showing one example of the energy harvesting device capable of converting heat energy into electrical energy.

The energy harvesting device further includes two coils and one magnetic material. Here, neodymium was used as the magnetic material, the weight of neodymium was adjusted to have an optimized moment of inertia, and the size of the coil was determined in consideration of the magnetic field of the magnetic material.

It can be seen that the energy harvesting device thus manufactured generated a voltage in response to the temperature, as shown in FIG. 32.

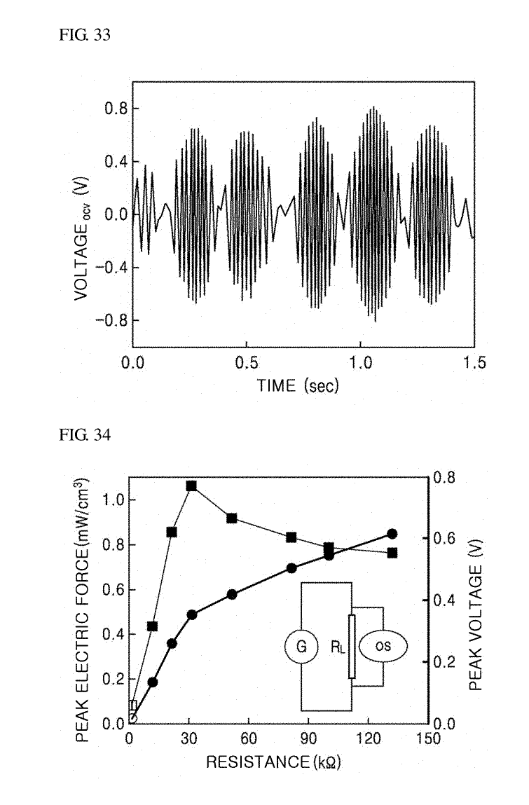

FIG. 33 is a graph of measuring a voltage generated according to time in the energy harvesting device (having an average temperature of 46° C.) of Preparative Example 13 when a temperature gradient of 12° C. occurs through convection using a heat plate.

As shown in FIG. 33, when a temperature gradient of 12° C. occurred, the voltage generated in the energy harvesting device was 0.81 V, and the rotation speed of the magnetic material in the energy harvesting device was 4,200 rpm.

FIG. 34 is a graph showing results of measuring an electric force and voltage according to the resistance of the energy harvesting device of Preparative Example 13.

The energy harvesting device had an energy of 0.43 μJ and a power of 4 μW under the same conditions as shown in FIG. 33 when the energy harvesting device had an external resistance of 31 kΩ. This was confirmed through impedance matching.

The efficiency of conversion of rotation energy into electrical energy by the energy harvesting device based on the rotation-type actuator was 9.3%, and calculated according to the following [Equation 9].

$$Efficiency ( η ) = \frac{{\int }_{{t}_{1}}^{{t}_{2}} \frac{{V}^{2}}{R} dt}{{\sum }_{n = 1}^{n} \frac{1}{2} I \cdot ω {n}^{2}} \qquad [ Equation 9 ]$$

In [Equation 9], V represents a voltage generated when the energy harvesting device has an external resistance,

I represents a moment of inertia, and

ω represents a rotation angular velocity.

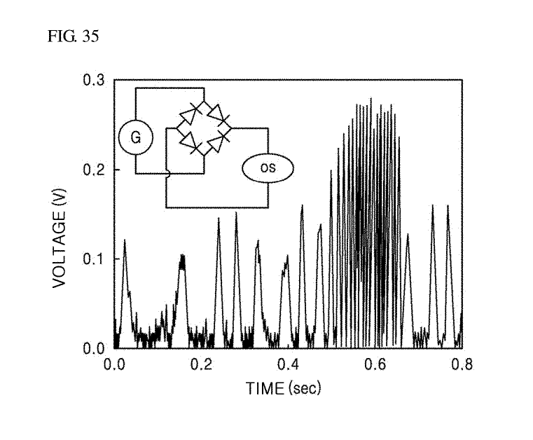

FIG. 35 is a graph showing a voltage signal obtained by rectifying a voltage, which is generated from the energy harvesting device of Preparative Example 13 under the same conditions as shown in FIG. 33, using a connection rectifier. The inset drawing is a drawing of a rectifier circuit.

It can be seen that the energy harvesting device based on the rotation-type actuator according to the present invention had a power of 1.1 mW/cm³ and an energy of 0.11 mJ/cm³, the values of which were significantly higher than those of the conventional energy harvesting devices using a temperature fluctuation.

For example, the expansion of a polymer and piezoelectric ZnO generated a power of 0.285 mW/cm³ at a temperature fluctuation of 43° C. (Non-patent Document 6), and hybrid SMA and a piezoelectric system generated an energy of 13.84 μJ/cm³ at a temperature fluctuation of 35° C. (Non-patent Document 7).

The AC voltage generated due to an irregular temperature gradient in the energy harvesting device was adjusted using a conventional connection rectifier. The adjusted voltage was 0.28 V because the voltage was reduced by the connection rectifier.

### INDUSTRIAL APPLICABILITY

The rotation-type actuator according to the present invention is modified to have a twisted and coiled fiber structure, and thus responds immediately, sensitively and reversibly to a temperature fluctuation.

Also, the rotation-type actuator can be useful in efficiently converting heat energy, which is wasted in the air, into mechanical energy without providing a high temperature fluctuation since the rotation-type actuator is sensitive to a persistent temperature gradient provided due to a temperature difference present in surrounding environments and has reversible, rapid and efficient actuation.

The rotation-type actuator has an excellent rotation speed, and also exhibits excellent service life characteristics because there is no significant decrease in rotation speed due to excellent durability and stability even when used for a long period of time. Accordingly, various types of the energy harvesting devices having improved efficiency in recovering heat energy as electrical energy using the rotation-type actuator, can be provided.

1. A rotation-type actuator comprising a single fiber or a multi-fiber having a twisted structure or a coiled shape, in the same direction or opposite directions,
wherein the fiber is divided into a top portion and a bottom portion with respect to the center thereof, at least one of the top and bottom portions of the fiber is fixed, and the top and bottom portions of the fiber each independently have a twisted structure or a coiled shape as a chiral Z-type or chiral S-type structure.

2. The rotation-type actuator of claim 1, wherein the fiber includes any one selected from the group consisting of nylon, shape-memory polyurethane, polyethylene, and rubber.

3. The rotation-type actuator of claim 1, wherein the rotation-type actuator has a rotating force due to contraction or expansion of the rotation-type actuator caused by a temperature fluctuation when both of the top and bottom portions of the rotation-type actuator are fixed, and
the rotation-type actuator has a change in rotating force and length due to the contraction or expansion of the rotation-type actuator caused by the temperature fluctuation when only one of the top and bottom portions of the rotation-type actuator is fixed.

4. The rotation-type actuator of claim 1, wherein the rotation-type actuator having the twisted structure has a bias angle of 20 to 60°.

5. The rotation-type actuator of claim 1, wherein the rotation-type actuator is tensile strained 1 to 25% based on the total length of the rotation-type actuator before being fixed, when both of the top and bottom portions of the rotation-type actuator are fixed.

6. The rotation-type actuator of claim 1, wherein a change in length according to temperature may be in a range of 5 to 30% based on the total length of the rotation-type actuator, when only one of the top and bottom portions of the rotation-type actuator is fixed.

7. The rotation-type actuator of claim 1, wherein the rotation-type actuator has a rotation speed of 100 to 200,000 rpm depending on the temperature fluctuation.

8. The rotation-type actuator of claim 1, wherein the rotation-type actuator has a 2-ply structure consisting of two strands of the rotation-type actuator, and is actuated like one strand.

9. The rotation-type actuator of claim 8, wherein, when the two strands of the rotation-type actuator have chiral S-type structures, the rotation-type actuator has an SZ coiled shape as the two strands of the rotation-type actuator are coiled in a Z type to form a 2-ply structure, and
when the two strands of the rotation-type actuator have chiral Z-type structures, the rotation-type actuator may have a ZS coiled shape as the two strands of the rotation-type actuator are coiled in an S type to form a 2-ply structure.

10. An energy harvesting device comprising:
the rotation-type actuator defined in claim 1 which contracts or expands in response to a temperature fluctuation;
at least one magnetic material; and
and least one coil,
wherein one of the magnetic material and the coil is located at a position inside the rotation-type actuator and rotating as the actuator rotates; and
the other of the magnetic material and the coil is arranged spaced apart from the rotation-type actuator.

11. The energy harvesting device of claim 10, wherein the magnetic material or the coil rotates as the rotation-type actuator rotates while contracting or expanding in response to the temperature fluctuation, and induces a change in magnetic flux passing through the interior of the coil to generate electrical energy.

12. The energy harvesting device of claim 10, wherein both end portions of the rotation-type actuator is fixed, or only one of the end portions of the rotation-type actuator is fixed, and
when one end portion of the rotation-type actuator is fixed, the energy harvesting device further includes a position variation support formed at the other unfixed end portion of the rotation-type actuator.

13. The energy harvesting device of claim 10, wherein the magnetic material is a permanent magnet, and the weight of the magnetic material is 10 to 1000 times higher than that of the rotation-type actuator.

14. The energy harvesting device of claim 12, wherein the position variation support is a magnetic material,
the energy harvesting device further includes a surrounding coil arranged spaced apart from the position variation support, and
electrical energy is generated through a change in magnetic flux passing through the interior of the coil while the position variation support is moving in a horizontal direction when the rotation-type actuator is tensile strained or contracted in response to the temperature fluctuation.

15. The energy harvesting device of claim 10, further comprising:
a plate attached to one of bottom and top portions of the energy harvesting device and provided with an opening/closing port capable of being opened or closed, and
at least one pin located at one position of the rotation-type actuator, arranged spaced apart from the plate and having the same shape as the opening/closing port.

16. The energy harvesting device of claim 15, wherein the rotation-type actuator rotates in response to a temperature, and the pin is located at a horizontal position spaced apart from the opening/closing port as the rotation-type actuator rotates, thereby blocking a flow of air flowing in through the opening/closing port.

17. (canceled)

18. An energy harvesting device comprising:
the rotation-type actuator of claim 1 which has both end portions fixed on a horizontal axis and contracts or expands in response to a temperature fluctuation;
an elevation unit provided at a central point in the rotation-type actuator;
at least one magnetic material provided at a lower portion of the elevation unit and coupled to the elevation unit to have a change in location as the rotation-type actuator rotates; and
at least one coil configured to generate an electric field through up-down movement of the magnetic material.

19. The energy harvesting device of claim 18, wherein the coil is in a cylindrical shape to surround a lateral surface of the magnetic material.

20-23. (canceled)

24. The rotation-type actuator of claim 1, wherein the multi-fiber having a twisted structure or a coiled shape is a polymer sheet in which a plurality of polymer fibers are aligned and twisted into a yarn.

25. (canceled)

26. The rotation-type actuator of claim 24, wherein the temperature gradient between the portion and the other portion of the rotation-type actuator is greater than or equal to 1° C.

27. The rotation-type actuator of claim 24, wherein the rotation-type actuator has a diameter of 0.5 to 200 μm.

28. The rotation-type actuator of claim 24, wherein the maximum temperature of the rotation-type actuator is in a range of 20 to 80° C.

29. The rotation-type actuator of claim 24, wherein, when the top and bottom portions of the polymer sheet rotate in the same direction or opposite directions to be manufactured into the rotation-type actuator, the rotation-type actuator is manufactured by rotating the top and bottom portions of the at least one polymer fiber or polymer sheet at a twist number of 2,000 to 60,000 turns/m and a temperature higher than the glass transition temperature (Tg) of the polymer fiber or polymer sheet.

30-45. (canceled)
